(19) United States
(12) Patent Application Publication
(10) Pub. No.: US 2024/0014899 A1
(43) Pub. Date: Jan. 11, 2024

(54) TRANSMITTER, TRANSMISSION DEVICE, COMMUNICATION DEVICE, AND COMMUNICATION SYSTEM

(71) Applicant: NEC Corporation, Tokyo (JP)

(72) Inventors: Koya TAKATA, Tokyo (JP); Hisashi MIZUMOTO, Tokyo (JP); Fujio OKUMURA, Kanagawa (JP)

(73) Assignee: NEC Corporation, Tokyo (JP)

(21) Appl. No.: 18/218,740

(22) Filed: Jul. 6, 2023

(30) Foreign Application Priority Data
Jul. 11, 2022 (JP) 2022-110938

(51) Int. Cl. H04B 10/112

(52) U.S. Cl. CPC H04B 10/1123

(57) ABSTRACT

A transmitter that includes a light source that includes a plurality of emitters, a spatial light modulator that includes a modulation part in which a plurality of modulation regions associated with each of a plurality of the emitters is set, curved mirrors that have a curved reflecting surface having a curvature relevant to a projection angle of projection light transmitted as a spatial light signal and disposed in association with each of a plurality of the modulation regions in such a way that, on the reflecting surface, modulated light modulated in each of a plurality of the modulation regions set in the modulation part of the spatial light modulator is reflected, and a light shielding band that is disposed between the spatial light modulator and the curved mirrors and removes an unnecessary light component included in the modulated light modulated in each of a plurality of the modulation regions.

This application is based upon and claims the benefit of priority from Japanese Patent Application No. 2022-110938, filed on Jul. 11, 2022, the disclosure of which is incorporated herein in its entirety by reference.

### TECHNICAL FIELD

The present disclosure relates to a transmitter or the like that transmits an optical signal propagating in a space.

### BACKGROUND ART

In optical space communication, optical signals (hereinafter, also referred to as a spatial light signal) propagating in space are transmitted and received without using a medium such as an optical fiber. In order to transmit the spatial light signal in a wide range, the projection angle of the projection light may be as large as possible. For example, if a light transmission device including a phase modulation-type spatial light modulator is used, the projection angle can be widened by controlling the pattern set in the modulation part of the spatial light modulator. If the spatial light signal can be transmitted in multiple directions around the light transmission device, a communication network using the spatial light signal can be constructed.

Patent Literature 1 (JP 2021 093663 A) discloses a light transmission device including a spatial light modulator. The device of Patent Literature 1 includes a spatial light modulator, a light source, a projection optical system, and a light transmission control means. A first region and a second region are allocated to the modulation part of the spatial light modulator. The light transmission control means sets the pattern of the phase image of the communication signal in the first region. The light transmission control means sets the pattern of the phase image of the dummy signal superimposed on the ghost image of the communication signal in the second region. The light source includes a first light source and a second light source. The first light source emits light for transmitting a communication signal toward the first region. The second light source emits light for transmitting a dummy signal toward the second region. The projection optical system transmits light emitted from the first light source and the second light source and modulated by the modulation part as a spatial light signal.

The device of Patent Literature 1 individually sets patterns for transmitting spatial light signals projected in different directions to two regions allocated to a modulation part of a spatial light modulator. The device of Patent Literature 1 irradiates two regions allocated to the modulation part with light from light sources associated with the regions. In the method of Patent Document 1, the modulation part of the spatial light modulator is divided into two to project the spatial light signal in different directions.

By further dividing the modulation part of the spatial light modulator, the spatial light signal can be transmitted in more directions. In the projection of the image using the spatial light modulation element, a higher-order image is generated by diffraction. By dividing the modulation part of the spatial light modulation element into a plurality of regions and providing a partition wall between adjacent regions, a higher-order image at the position of the partition wall can be removed. However, by providing the partition wall in the modulation part of the spatial light modulation element, the incident angle of light with respect to the modulation part is limited, and the number of light sources is restricted. Therefore, in a case where the modulation part is divided into a plurality of regions using the partition wall, due to a limit of the number of regions that can be divided, the number of communicable communication targets are limited.

An object of the present disclosure is to provide a transmitter or the like capable of transmitting a spatial light signal from which an unnecessary light component has been removed to a multidirectional communication target.

### SUMMARY

A transmitter according to one aspect of the present disclosure includes a light source that includes a plurality of emitters, a spatial light modulator that includes a modulation part in which a plurality of modulation regions associated with each of a plurality of the emitters is set, a plurality of curved mirrors that have a curved reflecting surface having a curvature relevant to a projection angle of projection light transmitted as a spatial light signal and disposed in association with each of a plurality of the modulation regions in such a way that, on the reflecting surface, modulated light modulated in each of a plurality of the modulation regions set in the modulation part of the spatial light modulator is reflected, and a light shielding band that is disposed between the spatial light modulator and the curved mirror and removes an unnecessary light component included in the modulated light modulated in each of a plurality of the modulation regions.

### BRIEF DESCRIPTION OF THE DRAWINGS

Exemplary features and advantages of the present invention will become apparent from the following detailed description when taken with the accompanying drawings in which:

FIG. 1 is a conceptual diagram illustrating an example of a configuration of a transmission device according to a first example embodiment;

FIG. 2 is a conceptual diagram illustrating an example of a configuration of a light source included in the transmission device according to the first example embodiment;

FIG. 3 is a conceptual diagram illustrating a configuration example of an emitter included in the light source included in the transmission device according to the first example embodiment;

FIG. 4 is a conceptual diagram illustrating a configuration example of an emitter included in the light source included in the transmission device according to the first example embodiment;

FIG. 5 is a conceptual diagram illustrating an example of a plurality of modulation regions allocated to a modulation part of a spatial light modulator included in the transmission device according to the first example embodiment;

FIG. 6 is a conceptual diagram illustrating an example of light irradiation to a modulation region allocated to the modulation part of the spatial light modulator included in the transmission device according to the first example embodiment;

FIG. 7 is a conceptual diagram illustrating an example of a configuration of a light shielding band included in the transmission device according to the first example embodiment;

FIG. 8 is a conceptual diagram for explaining a higher-order image included in modulated light modulated by the modulation part of the spatial light modulator included in the transmission device according to the first example embodiment;

FIG. 9 is a conceptual diagram for explaining shielding of the higher-order image by a light shielding band included in the transmission device according to the first example embodiment;

FIG. 10 is a conceptual diagram for explaining an arrangement example of the light source, the spatial light modulator, and the light shielding band included in the transmission device according to the first example embodiment;

FIG. 11 is a conceptual diagram for explaining an arrangement example of the light source, the spatial light modulator, and the light shielding band included in the transmission device according to the first example embodiment;

FIG. 12 is a conceptual diagram illustrating an example of projection of a spatial light signal by the transmission device according to the first example embodiment;

FIG. 13 is a conceptual diagram illustrating an example of projection of the spatial light signal by the transmission device according to the first example embodiment;

FIG. 14 is a conceptual diagram illustrating an example of projection of the spatial light signal by the transmission device according to the first example embodiment;

FIG. 15 is a conceptual diagram illustrating an example of projection of the spatial light signal by the transmission device according to the first example embodiment;

FIG. 16 is a conceptual diagram for explaining a position where the light source included in the transmission device according to the first example embodiment is arranged;

FIG. 17 is a conceptual diagram for explaining an arrangement example of the light source, the spatial light modulator, and the light shielding band included in the transmission device according to the first example embodiment;

FIG. 18 is a conceptual diagram for explaining an arrangement example of the light source, the spatial light modulator, and the light shielding band included in the transmission device according to the first example embodiment;

FIG. 19 is a conceptual diagram for explaining an arrangement example of the light source, the spatial light modulator, and the light shielding band included in the transmission device according to the first example embodiment;

FIG. 20 is a conceptual diagram illustrating an example of a configuration of the light shielding band included in the transmission device according to the first example embodiment;

FIG. 21 is a conceptual diagram illustrating an example of a configuration of the light shielding band included in the transmission device according to the first example embodiment;

FIG. 22 is a conceptual diagram illustrating an example of a configuration of a communication device according to a second example embodiment;

FIG. 23 is a conceptual diagram illustrating an example of a configuration of a reception device included in a communication device according to the second example embodiment;

FIG. 24 is a conceptual diagram for explaining Application Example 1 of the second example embodiment;

FIG. 25 is a conceptual diagram for describing Application Example 1 of the second example embodiment;

FIG. 26 is a conceptual diagram illustrating an example of a configuration of a communication device according to Application Example 1 of the second example embodiment;

FIG. 27 is a conceptual diagram illustrating an example of a configuration of a transmission mechanism included in the communication device according to Application Example 1 of the second example embodiment;

FIG. 28 is a conceptual diagram illustrating an example of a configuration of a reception mechanism included in the communication device according to Application Example 1 of the second example embodiment;

FIG. 29 is a conceptual diagram illustrating an example of a configuration of the communication device according to Application Example 1 of the second example embodiment;

FIG. 30 is a conceptual diagram illustrating an example of a configuration of the communication device according to Application Example 1 of the second example embodiment;

FIG. 31 is a conceptual diagram for explaining an example of communication using a spatial light signal by the communication device according to Application Example 1 of the second example embodiment;

FIG. 32 is a conceptual diagram for explaining an example of communication using a spatial light signal by the communication device according to Application Example 1 of the second example embodiment;

FIG. 33 is a conceptual diagram for explaining an example of communication using a spatial light signal by the communication device according to Application Example 1 of the second example embodiment;

FIG. 34 is a conceptual diagram for explaining Application Example 2 of the second example embodiment;

FIG. 35 is a conceptual diagram for explaining a projection range of a spatial light signal by a communication device according to Application Example 2 of the second example embodiment;

FIG. 36 is a conceptual diagram illustrating an example of a configuration of a transmission mechanism included in the communication device according to Application Example 2 of the second example embodiment;

FIG. 37 is a conceptual diagram for explaining transmission of a spatial light signal by the communication device according to Application Example 2 of the second example embodiment;

FIG. 38 is a conceptual diagram for explaining pulsed light transmitted from the communication device according to Application Example 2 of the second example embodiment;

FIG. 39 is a conceptual diagram illustrating an example in which the communication device according to Application Example 2 of the second example embodiment is mounted on a drone;

FIG. 40 is a conceptual diagram for explaining Application Example 3 of the second example embodiment;

FIG. 41 is a conceptual diagram for explaining a projection range of a spatial light signal by the communication device according to Application Example 3 of the second example embodiment;

FIG. 42 is a conceptual diagram for explaining Application Example 4 of the second example embodiment;

FIG. 43 is a conceptual diagram illustrating an example of a configuration of a transmitter according to a third example embodiment; and

FIG. 44 is a block diagram illustrating an example of a hardware configuration that executes processing and control according to each example embodiment.

### EXAMPLE EMBODIMENT

Example embodiments of the present invention will be described below with reference to the drawings. In the following example embodiments, technically preferable limitations are imposed to carry out the present invention, but the scope of this invention is not limited to the following description. In all drawings used to describe the following example embodiments, the same reference numerals denote similar parts unless otherwise specified. In addition, in the following example embodiments, a repetitive description of similar configurations or arrangements and operations may be omitted.

In all the drawings used for description of the following example embodiments, the directions of the arrows in the drawings are merely examples, and do not limit the directions of light and signals. Aline indicating a trajectory of light in the drawings is conceptual, and does not accurately indicate an actual traveling direction or state of light. For example, in the drawings, a change in a traveling direction or a state of light due to refraction, reflection, diffusion, or the like at an interface between air and a substance may be omitted, or a light flux may be expressed by one line. There is a case where hatching is not applied to the cross section for reasons such as an example of a light path is illustrated or the configuration is complicated.

### First Example Embodiment

First, a transmission device according to a first example embodiment will be described with reference to the drawings. The transmission device of the present example embodiment is used for optical space communication in which optical signals (hereinafter, also referred to as a spatial light signal) propagating in a space are transmitted and received without using a medium such as an optical fiber. The transmission device of the present example embodiment may be used for applications other than optical space communication as long as the transmission device transmits light propagating in a space. The drawings used in the description of the present example embodiment are conceptual and do not accurately depict an actual structure.

(Configuration)

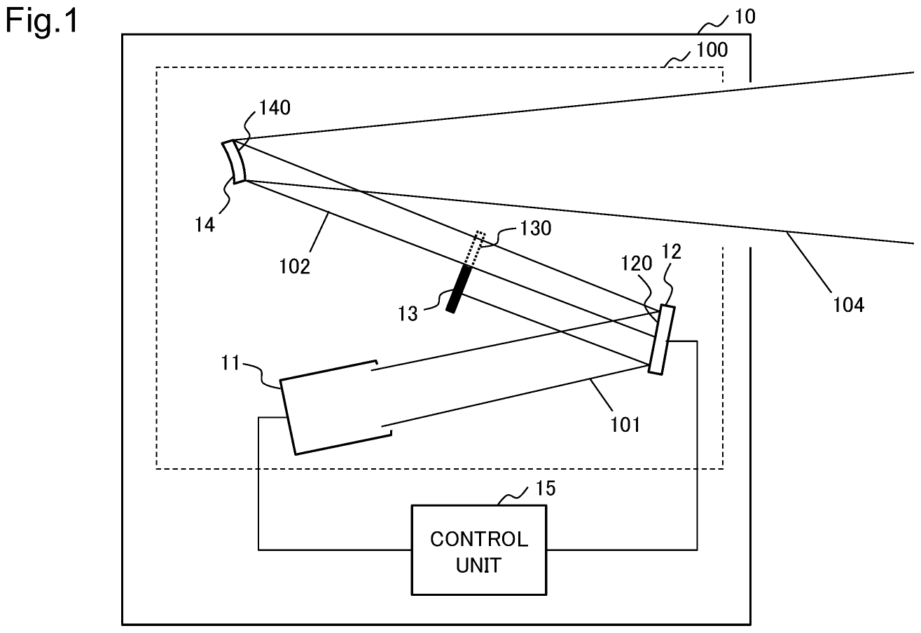

FIG. 1 is a conceptual diagram illustrating an example of a configuration of a transmission device 10 according to the present example embodiment. The transmission device 10 includes a light source 11, a spatial light modulator 12, a light shielding band 13, a curved mirror 14, and a control unit 15. The light source 11, the spatial light modulator 12, the light shielding band 13, and the curved mirror 14 constitute a transmitter 100. FIG. 1 is a side view of an internal configuration of the transmission device 10 as viewed from a lateral direction. Apart (light shielding band 13) of the internal configuration of the transmission device 10 shows a cross section. FIG. 1 is conceptual, and does not accurately represent a shape of each component, a positional relationship between components, traveling of light, and the like. Although only one light shielding band 13 is illustrated in FIG. 1, the transmission device 10 may include a plurality of light shielding bands 13. Although only one curved mirror 14 is illustrated in FIG. 1, the transmission device 10 includes the curved mirrors 14 in the number relevant to the projection direction of the projection light 104.

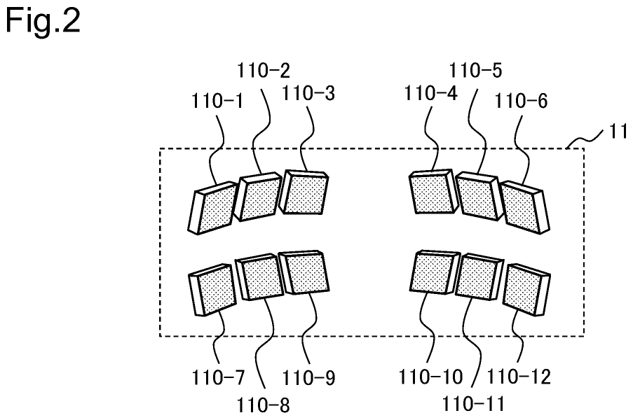

The light source 11 emits parallel light 101 under the control of control unit 15. FIG. 2 is a conceptual diagram illustrating an example of a configuration of the light source 11. The light source 11 includes a plurality of emitters 110-1 to 110-12. Each of the plurality of emitters 110-1 to 110-12 is associated with each of the plurality of modulation regions set in a modulation part 120 of the spatial light modulator 12. The emission surfaces of the plurality of emitters 110-1 to 110-12 are directed to the associated modulation region. In the present example embodiment, the emission surfaces of the plurality of emitters 110-1 to 110-12 and the modulation part 120 of the spatial light modulator 12 are disposed to face each other. The plurality of emitters 110-1 to 110-12 and the plurality of modulation regions set in the modulation part 120 of the spatial light modulator 12 are associated with each other in an oblique positional relationship. Each of the plurality of emitters 110-1 to 110-12 emits the parallel light 101 toward the associated modulation region. The number of the emitters 110 included in the light source 11 is not limited to 12. The number of the emitters 110 may be less than 12 or may be 13 or more.

The emitter 110 included in the light source 11 emits laser light in a predetermined wavelength band under the control of the control unit 15. The wavelength of the laser light emitted from the emitter 110 is not particularly limited, and may be selected according to the application. For example, the emitter 110 emits laser light in visible or infrared wavelength bands. For example, in the case of near infrared rays of 800 to 900 nanometers (nm), the laser class can be given, and thus the sensitivity can be improved by about 1 digit as compared with other wavelength bands. For example, a high-power laser light source can be used for infrared rays in a wavelength band of 1.55 micrometers (μm). As a laser light source that emits infrared rays in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser light is, the larger the diffraction angle can be made and the higher the energy can be set.

The light source 11 includes a collimator (not illustrated). The collimator is disposed in each of the plurality of emitters 110-1 to 110-12. The collimator converts the laser light emitted from the emitter 110 into the parallel light 101. The converted parallel light 101 is emitted from the light source 11. The parallel light 101 emitted from the light source 11 travels toward the modulation part 120 of the spatial light modulator 12. The collimator may be omitted according to the distance between the light source 11 and the spatial light modulator 12 or the like.

For example, the emitter 110 included in the light source is achieved by a surface emitting laser. An example of the surface emitting laser is a VCSEL (Vertical-Cavity Surface-Emitting Laser). The VCSEL laser emits laser light of circular wide radiation. As an example of the surface emitting laser, there is a PCSEL (Photonic Crystal Surface Emitting Laser). The PCSEL laser emits laser light of circular narrow radiation. Compared with the VCSEL laser, the PCSEL laser emits a uniform laser light.

For example, the emitter 110 included in the light source is achieved by a fiber array laser. In the fiber array laser, a laser light source and an emission unit (collimator) are connected by an optical waveguide (optical fiber). The laser light emitted from the laser light source is emitted from the emission unit through the waveguide. When the fiber array laser is used, the laser light source and the emission unit can be disposed at different positions. Therefore, when the fiber array laser is used, even if the emission unit of the parallel light 101 and the spatial light modulator 12 are brought close to each other, the laser light source can be disposed at a position away from the spatial light modulator 12, so that the thermal problem can be solved. Hereinafter, two configuration examples of the fiber array laser will be described.

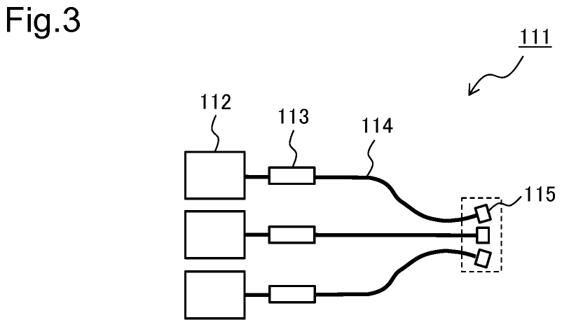

FIG. 3 is a conceptual diagram illustrating a configuration of a first example (emitter 111) of the emitter 110 included in the light source 11. The emitter 111 is an example of a fiber array laser in which three emitters 110 are integrated. The emitter 111 includes three sets of a modulation driver 112, a laser light source 113, an optical fiber 114, and a micro collimator 115. The modulation driver 112 drives the laser light source 113 to modulate the laser light emitted from the laser light source 113. The laser light source 113 is a laser light source that can be directly modulated. The laser light source 113 emits the modulated laser light in accordance with driving by the modulation driver 112. The laser light emitted from the laser light source 113 travels toward the micro collimator 115 through the optical fiber 114. The optical fiber 114 is an optical waveguide that guides laser light emitted from the laser light source 113 toward the micro collimator 115. A material of the optical fiber 114 is selected according to a wavelength band of laser light emitted from the laser light source 113. The laser light enters the micro collimator 115 through the optical fiber 114. The micro collimator 115 converts the incident laser light into the parallel light 101. For example, the micro collimator 115 is micro-opticized and integrally formed. The converted parallel light 101 is emitted from the light source 11.

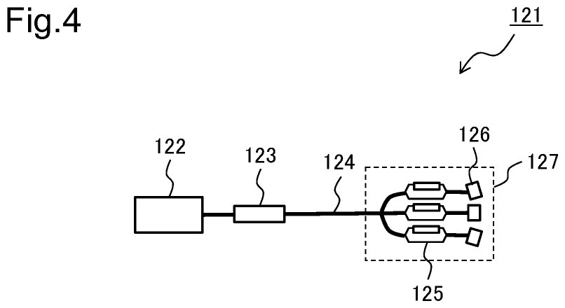

FIG. 4 is a conceptual diagram illustrating a configuration of a second example (emitter 110) of the emitter 121 included in the light source 11. The emitter 121 is an example of a fiber array laser in which three emitters 110 are integrated. The emitter 121 includes a direct current source 122, a laser light source 123, an optical fiber 124, a modulator 125, and a micro collimator 126. The modulator 125 and the micro collimator 126 constitute an external modulator array 127 with a micro collimator. The emitter 121 includes a set of direct current source 122 and laser light source 123. The emitter 110 includes three sets of modulator 125 and micro collimator 126. The direct current source 122 is a current source that supplies a direct current to the laser light source 123. The laser light source 123 is a continuous wave (CW) laser light source that continuously oscillates laser output. The laser light source 123 emits laser light in response to supply of direct current from the direct current source 122. The laser light emitted from the laser light source 123 travels toward the modulator 125 through the optical fiber 124. The optical fiber 124 is an optical waveguide that guides laser light emitted from the laser light source 123 toward the modulator 125. A material of the optical fiber 124 is selected according to a wavelength band of laser light emitted from the laser light source 123. The optical fiber 124 is also disposed between the modulator 125 and the micro collimator 126. The laser light enters the modulator 125 through the optical fiber 124. The modulator 125 is a Mach-Zehnder type optical modulator. The modulator 125 may be an electric field absorption type optical modulator. The modulator 125 modulates the incident laser light. The laser light modulated by the modulator 125 enters the micro collimator 126. The micro collimator 126 converts the incident laser light into the parallel light 101. For example, the micro collimator 126 is micro-optimized and integrally formed. The converted parallel light 101 is emitted from the light source 11.

The spatial light modulator 12 is a phase modulation-type spatial light modulator. The spatial light modulator 12 includes the modulation part 120. A plurality of modulation regions are set in the modulation part 120. The number of modulation regions set in the modulation part 120 is set in accordance with the number of emitters 110 included in the light source 11.

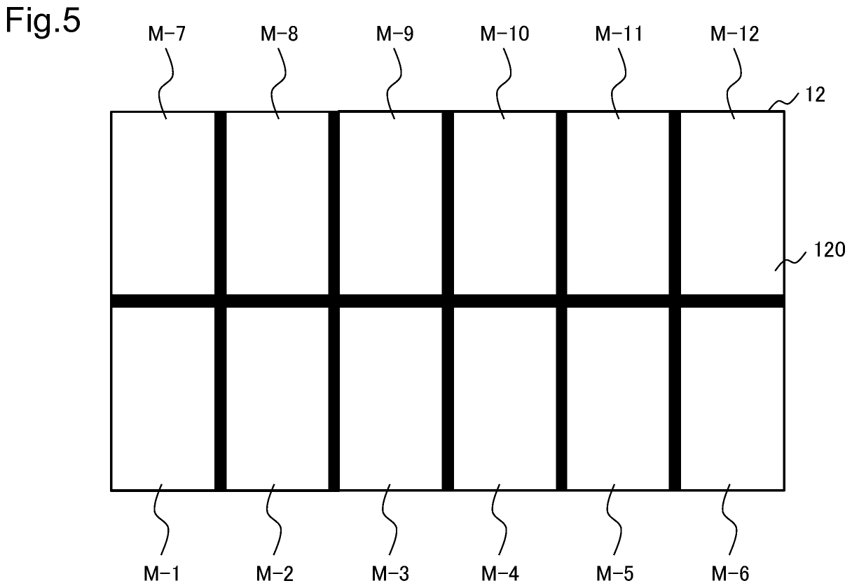

FIG. 5 is a conceptual diagram illustrating an example of a plurality of modulation regions M set in the modulation part 120. In the example of FIG. 5, 12 modulation regions M-1 to M-12 are set. A dead zone is set between the adjacent modulation regions M. A black stripe-shaped phase image is set in the dead zone. For example, in a case where the pixels of modulation part 120 are 1080 rows×1920 columns, if the dead zone width is set to 50 pixels, pixels of 515 rows×278 columns can be secured for one modulation region M.

Each of the plurality of modulation regions M-1 to M-12 is associated with each of the plurality of emitters 110-1 to 110-12 included in the light source 11. The plurality of emitters 110-1 to 110-12 and the plurality of modulation regions M-1 to M-12 are associated with each other in an oblique positional relationship. Each of the plurality of modulation regions M-1 to M-12 is irradiated with the parallel light 101 derived from the laser light emitted from the associated emitter 110. Each of the plurality of modulation regions M-1 to M-12 is irradiated with the parallel light 101 obliquely with respect to the major axis direction and the minor axis direction of the modulation part 120. In the present example embodiment, the emitter 110 and the modulation region M having a point-symmetric positional relationship with respect to the emission surface of the light source 11 and the center point of the modulation part 120 are associated with each other. By being associated with such a positional relationship, the distance between the emitter 110 and the modulation region M can be sufficiently obtained even if the light source 11 and the spatial light modulator 12 are brought close to each other. Therefore, the size of the transmitter 100 can be reduced.

The modulation region M-1 is irradiated with the parallel light 101 derived from the laser light emitted from the emitter 110-1. The modulation region M-2 is irradiated with the parallel light 101 derived from the laser light emitted from the emitter 110-2. The modulation region M-3 is irradiated with the parallel light 101 derived from the laser light emitted from the emitter 110-3. The modulation region M-4 is irradiated with the parallel light 101 derived from the laser light emitted from the emitter 110-4. The modulation region M-5 is irradiated with the parallel light 101 derived from the laser light emitted from the emitter 110-5. The modulation region M-6 is irradiated with the parallel light 101 derived from the laser light emitted from the emitter 110-6. The modulation region M-7 is irradiated with the parallel light 101 derived from the laser light emitted from the emitter 110-7. The modulation region M-8 is irradiated with the parallel light 101 derived from the laser light emitted from the emitter 110-8. The modulation region M-9 is irradiated with the parallel light 101 derived from the laser light emitted from the emitter 110-9. The modulation region M-10 is irradiated with the parallel light 101 derived from the laser light emitted from the emitter 110-10. The modulation region M-11 is irradiated with the parallel light 101 derived from the laser light emitted from the emitter 110-11. The modulation region M-12 is irradiated with the parallel light 101 derived from the laser light emitted from the emitter 110-12. When the parallel light 101 derived from the laser light emitted from the emitter 110 is obliquely incident on the modulation surface of the modulation region M, the correspondence relationship between the modulation region M and the emitter 110 is not limited to the above correspondence relationship.

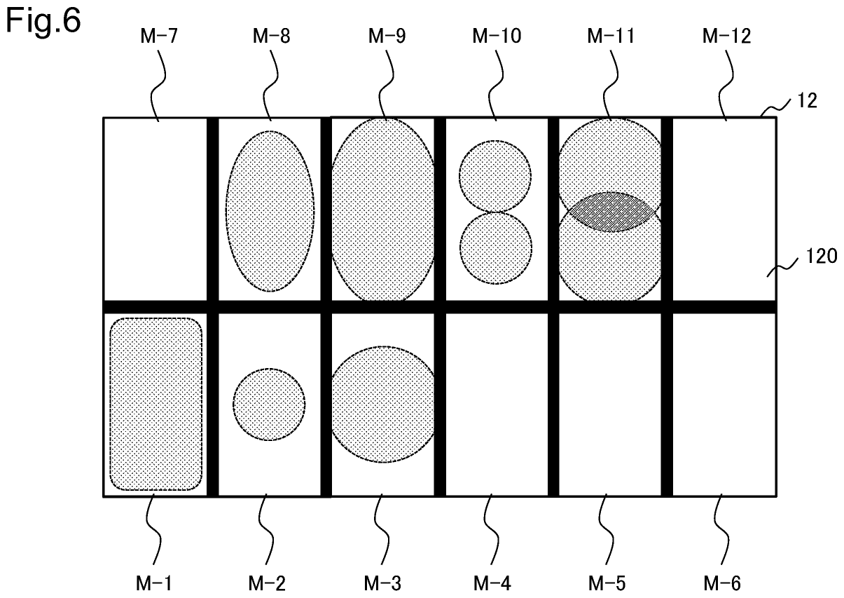

FIG. 6 is a conceptual diagram for explaining an irradiation pattern of the parallel light 101 with which the modulation region M set in the modulation part 120 is irradiated. In FIG. 6, the irradiation pattern of the parallel light 101 is indicated by hatching. The modulation region M-1 is irradiated with the parallel light 101 in a rectangular irradiation pattern. The rectangular irradiation pattern is an ideal pattern without protruding to the dead zone. In order to emit parallel light in a rectangular irradiation pattern, an optical system for beam shaping is required.

The modulation regions M-2 and M-3 are irradiated with the parallel light 101 in a circular irradiation pattern. In the circular irradiation pattern with which the MR-2 is irradiated, there is no protrusion to the dead zone, and the area of the region irradiated with the parallel light 101 is small. The circular irradiation pattern with which the MR-3 is irradiated protrudes into the dead zone. Compared with the circular irradiation pattern with which the MR-2 is irradiated, the circular irradiation pattern with which the MR-3 is irradiated has a larger area of a region irradiated with the parallel light 101. In the case of the surface emitting laser, the irradiation patterns of the modulation regions M-2 and M-3 can be achieved. When the spread of the irradiation diameter is small, the irradiation pattern of the modulation region M-3 can be achieved.

The modulation regions M-8 and M-9 are irradiated with the parallel light 101 in an elliptical irradiation pattern. The elliptical irradiation pattern with which the MR-8 is irradiated does not protrude to the dead zone, and the area of the region irradiated with the parallel light 101 is larger than that of the circular irradiation pattern with which the MR-2 is irradiated. The circular irradiation pattern with which the MR-9 is irradiated protrudes into the dead zone. The circular irradiation pattern with which the MR-8 is irradiated has a larger area irradiated with the parallel light 101 than the elliptical irradiation pattern with which the MR-9 is irradiated. A semiconductor laser of an edge emitter type emits an elliptical beam. In the case of the edge emitter laser, the irradiation patterns of the modulation regions M-8 and M-9 can be achieved. When the spread of the irradiation diameter is small, the irradiation pattern of the modulation region M-8 can be achieved. In the case of the semiconductor laser of the edge emitter type, since the major axis direction of the ellipse and the polarization direction are aligned, a complicated collimating system is unnecessary.

The modulation regions M-10 and M-11 are irradiated with the parallel light 101 in two circular irradiation patterns. In the case of the irradiation patterns of the modulation regions M-10 and M-11, two emitters 110 are configured for one modulation region M. The two circular irradiation patterns with which the MR-11 is irradiated do not protrude to the dead zone, and the area of the region irradiated with the parallel light 101 is larger than that of the circular irradiation pattern with which the MR-2 is irradiated. The two circular irradiation patterns with which the MR-12 is irradiated protrude to the dead zone. Compared with the two circular irradiation patterns with which the MR-10 is irradiated, the two circular irradiation patterns with which the MR-12 is irradiated have a larger area irradiated with the parallel light 101. In the case of the surface emitting laser, the irradiation patterns of the modulation regions M-10 and M-11 can be achieved. When the spread of the irradiation diameter is small, the irradiation pattern of the modulation region M-11 can be achieved.

A pattern (also referred to as a phase image) corresponding to the image displayed by the projection light 104 is set in each of the plurality of modulation regions M under the control of control unit 15. The parallel light 101 incident on each of the plurality of modulation regions M-1 to M-12 set in the modulation part 120 is modulated according to the pattern (phase image) set in each of the plurality of modulation regions M-1 to M-12. Modulated light 102 modulated in each of the plurality of modulation regions M-1 to M-12 travels toward a reflecting surface 140 of the curved mirror 14 associated with each of the modulation regions M-1 to M-12.

For example, the spatial light modulator 12 is achieved by a spatial light modulator using ferroelectric liquid crystal, homogeneous liquid crystal, vertical alignment liquid crystal, or the like. For example, the spatial light modulator 12 can be achieved by liquid crystal on silicon (LCOS). The spatial light modulator 12 may be achieved by a micro electro mechanical system (MEMS). In the spatial light modulator 12 of the phase modulation type, the energy can be concentrated on the portion of the image by operating to sequentially switch the portion on which the projection light 104 is projected. Therefore, in the case of using the spatial light modulator 12 of the phase modulation type, if the output of the light source 11 is the same, the image can be displayed brighter than other methods.

The plurality of modulation regions M are divided into a plurality of regions (also referred to as tiling). For example, the modulation region M is divided into regions (also referred to as tiles) having a desired aspect ratio. A phase image is allocated to each of the plurality of tiles set in the modulation region M. Each of the plurality of tiles includes a plurality of pixels. A phase image relevant to a projected image is set to each of the plurality of tiles.

A phase image is tiled to each of the plurality of tiles allocated to the modulation region M. For example, a phase image generated in advance is set in each of the plurality of tiles. When the modulation region M is irradiated with the parallel light 101 in a state where the phase image is set in the plurality of tiles, the modulated light 102 that forms an image relevant to the phase image of each tile is emitted. As the number of tiles set in the modulation region M increases, a clear image can be displayed. However, when the number of pixels of each tile decreases, the resolution decreases. Therefore, the size and number of tiles set in the modulation region M are set according to the application.

The light shielding band 13 is disposed between the spatial light modulator 12 and the curved mirror 14. An opening 130 through which the modulated light 102 projected as the projection light 104 passes is formed in the light shielding band 13. The light shielding band 13 shields 0^{th}-order light included in the modulated light 102. The light shielding band 13 shields the periphery of the 0^{th}-order image included in the modulated light 102. That is, the light shielding band 13 shields 0^{th}-order light and a light component forming a higher-order image included in the modulated light.

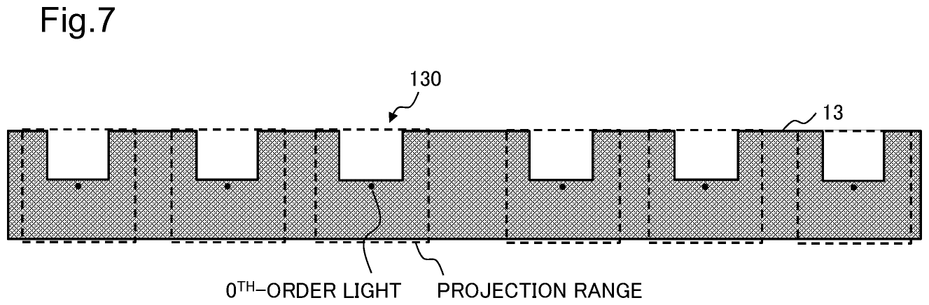

FIG. 7 is a conceptual diagram illustrating an example of the light shielding band 13. The light shielding band 13 of FIG. 7 is relevant to the six modulation regions M-1 to M-6 set at the lower stage of the modulation part 120 or the six modulation regions M-7 to M-12 set at the upper stage of the modulation part 120 among the plurality of modulation regions M set as illustrated in FIGS. 5 and 6. As will be described later, two light shielding bands 13 are disposed in correspondence with the modulation regions M-1 to M-6 set in the lower stage and the modulation regions M-7 to M-12 set in the upper stage. A specific arrangement of the light shielding bands 13 will be described later.

In the light shielding band 13, a projection range associated with each of the plurality of modulation regions M is set. The opening 130 is formed in each projection range. The opening 130 is a portion that allows a light component forming the 0^{th}-order image to pass through in the image formed by the modulated light 102. The opening 130 is formed avoiding a position irradiated with the 0^{th}-order light included in the modulated light 102. That is, the 0^{th}-order light included in the modulated light 102 is shielded by the light shielding band 13, and therefore does not travel toward the curved mirror 14.

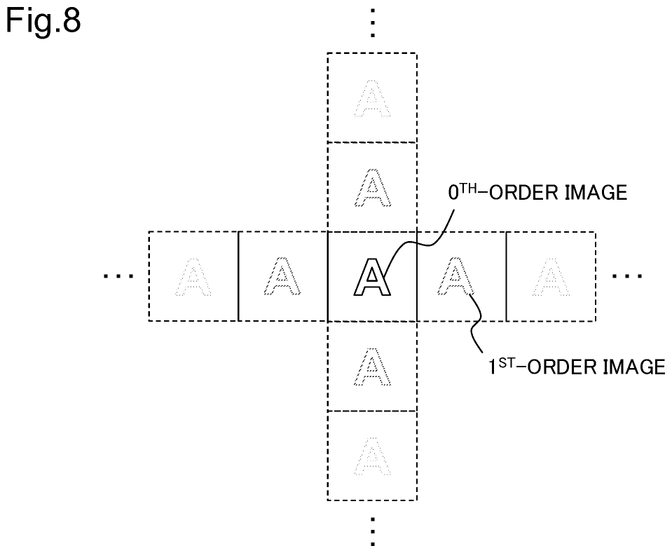

FIG. 8 is a conceptual diagram for explaining an image formed by the modulated light 102 modulated by the modulation part 120 of the spatial light modulator 12. In the case of using the spatial light modulator 12 of a phase modulation-type, an image is formed using a diffraction phenomenon, so that a higher-order image is generated similarly to the diffraction grating. In the example of FIG. 8, the 0^{th}-order image at the center is an image to be projected, and an image of an order higher than or equal to the 1V-order image is a higher-order image. Since the power of a higher-order image decreases as the order increases, it becomes more difficult to visually recognize the higher-order image as the order increases. However, higher-order images are not completely invisible. For example, in a case where the modulation part 120 of the spatial light modulator 12 is divided into a plurality of modulation regions M, a higher-order image can be removed by providing a partition wall between adjacent modulation regions M. However, when the partition wall is provided, the irradiation angle of the parallel light 101 is limited, and the number of divisions of the modulation part 120 is limited.

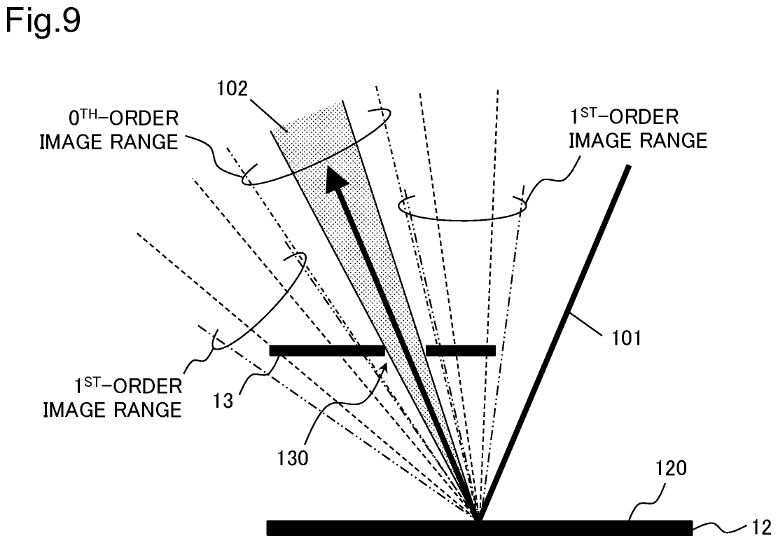

FIG. 9 is a conceptual diagram for explaining an example of shielding of a higher-order image by the light shielding band 13. The parallel light 101 emitted to the modulation part 120 of the spatial light modulator 12 is modulated into the modulated light 102 by the modulation part 120. Most of the light component forming the 0^{th}-order image included in the modulated light 102 passes through the opening 130 of the light shielding band 13. Among the light components included in the modulated light 102 and forming the 0^{th}-order image, the light component forming the image of the peripheral portion is shielded by the light shielding band 13. The light component forming the 1^{st}-order image included in the modulated light 102 is shielded by the light shielding band 13. Since the 2^{nd} or higher-order image has reduced luminance and is projected in a direction corresponding to the irradiation angle of the parallel light 101, most of the 2^{nd} or higher-order image is not projected to the outside of the housing (not illustrated) of the transmission device 10.

In the present example embodiment, since the plurality of modulation regions M are divided by the dead zone, there is no limitation on the irradiation angle of the parallel light 101. Therefore, according to the present example embodiment, the modulation part 120 can be divided into more modulation regions M as compared with the case where the partition wall is provided. According to the present example embodiment, since the incident angle of the parallel light 101 with respect to the modulation part 120 of the spatial light modulator 12 can be increased, the light source 11 can be brought close to the spatial light modulator 12. For example, if a surface emitting laser is used for the emitter 110 included in the light source 11, the collimator can be eliminated from the light source 11.

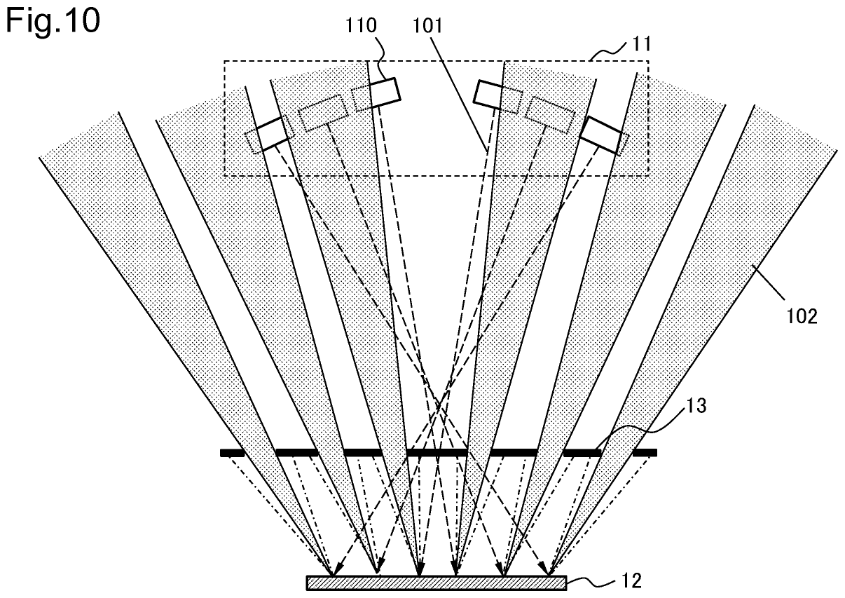

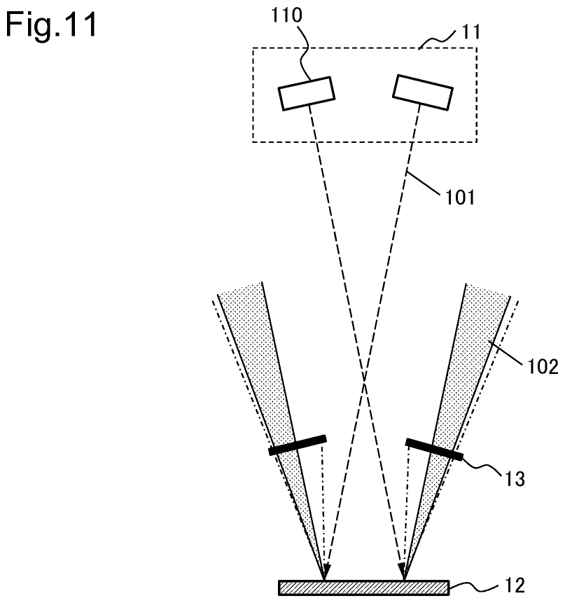

FIGS. 10 and 11 are conceptual diagrams illustrating arrangement examples of the light source 11, the spatial light modulator 12, and the light shielding band 13. FIG. 10 is a diagram of the spatial light modulator 12 as viewed from the major axis direction. FIG. 11 is a diagram of the spatial light modulator 12 as viewed from the minor axis direction. In FIGS. 10 and 11, the overlapping configuration is omitted. FIGS. 10 and 11 conceptually illustrate the optical path of the parallel light 101 emitted from the light source and the modulated light 102 modulated by the modulation part 120 of the spatial light modulator 12. The light shielding band 13 is disposed at a position deviated from the optical path of the parallel light 101 emitted from the plurality of emitters 110. In the examples of FIGS. 10 and 11, the interval between the light source 11 and the spatial light modulator 12 is larger than the interval between the spatial light modulator 12 and the light shielding band 13.

The parallel light 101 emitted from the plurality of emitters 110 is irradiated to the modulation part 120 of the spatial light modulator 12. The parallel light 101 emitted from each of the plurality of emitters 110 is irradiated to the associated modulation region M. The parallel light 101 with respect to the modulation part 120 is incident on both the major axis and the minor axis of the spatial light modulator 12 with an angle. That is, the plane of the modulation part 120 is irradiated with the parallel light 101 non-perpendicularly. The modulated light 102 modulated by each of the plurality of modulation regions M set in the modulation part 120 travels toward the reflecting surface 140 of the curved mirror 14 with which each of the modulation regions M is associated. Of the modulated light 102, the 0^{th}-order light and a light component that forms a higher-order image are shielded by the light shielding band 13. In the modulated light 102, a light component forming the 0^{th}-order image passes through the opening 130 of the light shielding band 13 and travels toward the reflecting surface 140 of the curved mirror 14.

The curved mirror 14 is a reflecting mirror having the curved reflecting surface 140. One curved mirror 14 is disposed in association with each of the plurality of modulation regions M set in the modulation part 120 of the spatial light modulator 12. In the present example embodiment, 12 curved mirrors 14 are disposed in association with each of 12 modulation regions M. The reflecting surface 140 of the curved mirror 14 has a curvature corresponding to the projection angle of the projection light 104. The shape of the reflecting surface 140 of the curved mirror 14 is not limited as long as it includes a curved portion. For example, the reflecting surface 140 of the curved mirror 14 has a shape of a side surface of a cylinder. For example, the reflecting surface 140 of the curved mirror 14 may be a free-form surface or a spherical surface. For example, the reflecting surface 140 of the curved mirror 14 may have a shape in which a plurality of curved surfaces are combined instead of a single curved surface. For example, the reflecting surface 140 of the curved mirror 14 may have a shape in which a curved surface and a flat surface are combined.

The curved mirror 14 is disposed with the reflecting surface 140 facing the modulation region M set in the modulation part 120 of the spatial light modulator 12. The curved mirror 14 is disposed on an optical path of the modulated light 102. The reflecting surface 140 is irradiated with light components that have passed through the opening 130 of the light shielding band 13 in the modulated light 102 modulated by the modulation part 120. The modulated light 102 irradiated to the reflecting surface 140 is reflected by the reflecting surface 140. The light (projection light 104) reflected by the reflecting surface 140 is enlarged at an enlargement ratio corresponding to the curvature of the reflecting surface 140 and projected.

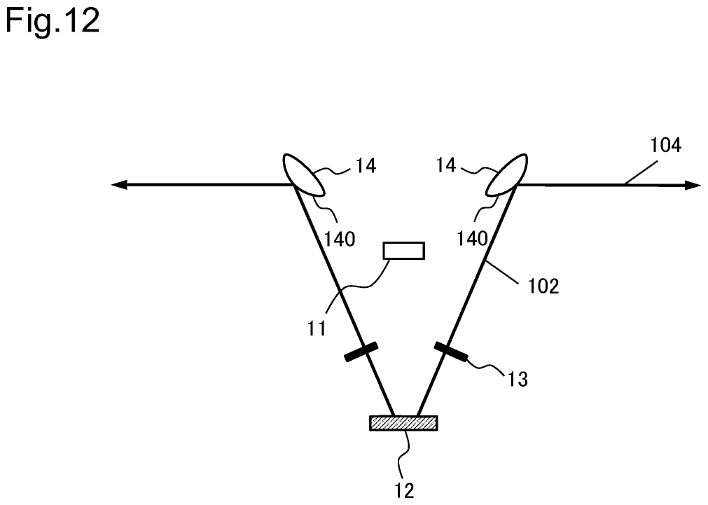

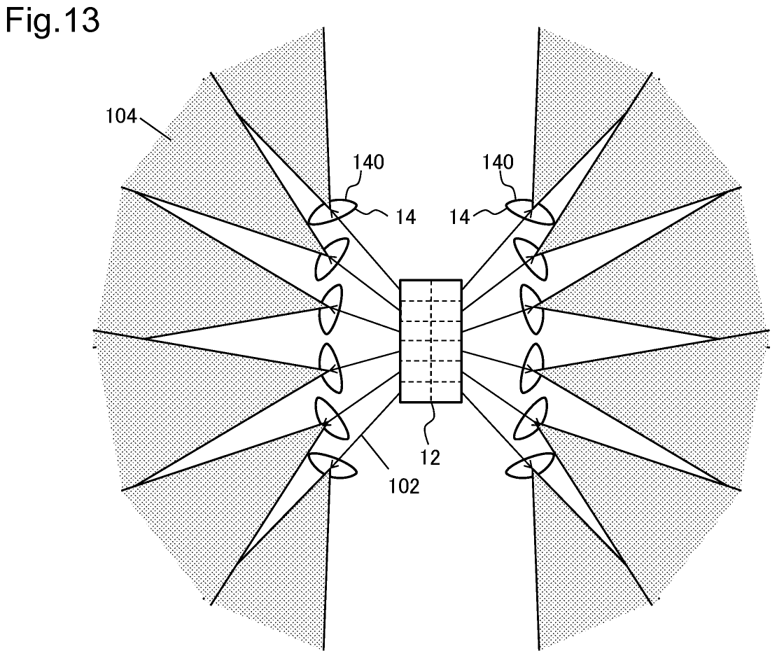

FIGS. 12 and 13 are conceptual diagrams for explaining an example of light reflection by the curved mirror 14. FIGS. 12 and 13 illustrate examples in which the spatial light signal (projection light 104) is projected in the direction of 360 degrees. FIG. 12 is a diagram of the spatial light modulator 12 as viewed from the minor axis direction. FIG. 13 is a diagram of the spatial light modulator 12 as viewed from the back side. In FIGS. 12 and 13, the light shielding band 13 is omitted. The plurality of curved mirrors 14 are associated with one of the plurality of modulation regions M set in the modulation part 120 of the spatial light modulator 12. In the examples of FIGS. 12 and 13, the projection light 104 is enlarged along the horizontal direction (the vertical direction with respect to the sheet of FIG. 13) according to the curvature of the irradiation range of the modulated light 102 on the reflecting surface 140 of the curved mirror 14. The projection light 104 is also enlarged in the vertical direction (the vertical direction in the sheet of FIG. 13) as it goes away from a transmission device 21.

The plurality of curved mirrors 14 are disposed with the reflecting surface 140 facing different directions. The reflecting surfaces 140 of the six curved mirrors 14 disposed on the left side are directed to the left side in the plane of the paper of FIG. 13. The reflecting surfaces 140 of the six curved mirrors 14 disposed on the left side are responsible for a projection range of 180 degrees on the left side in the plane of the paper of FIG. 13. The reflecting surfaces 140 of the six curved mirrors 14 disposed on the right side are directed to the right in the plane of the paper of FIG. 13. The reflecting surfaces 140 of the six curved mirrors 14 disposed on the right side are responsible for the projection range of 180 degrees on the right side in the plane of the paper of FIG. 13. For example, if the projection angle of one curved mirror 14 is set to 30 degrees or more, the projection range of 360 degrees can be covered by summing the projection angles taken charge of by the 12 curved mirrors 14.

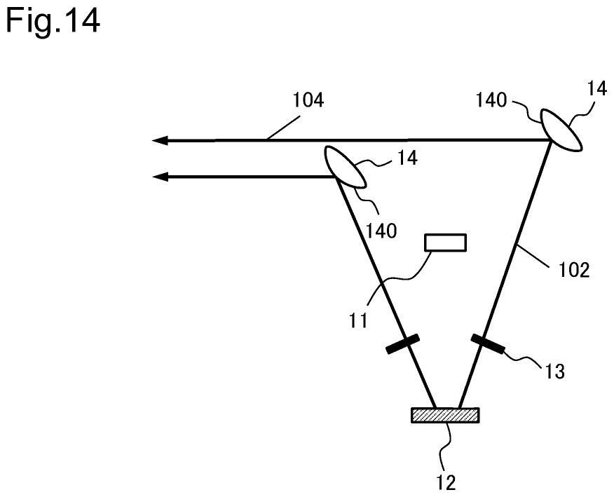

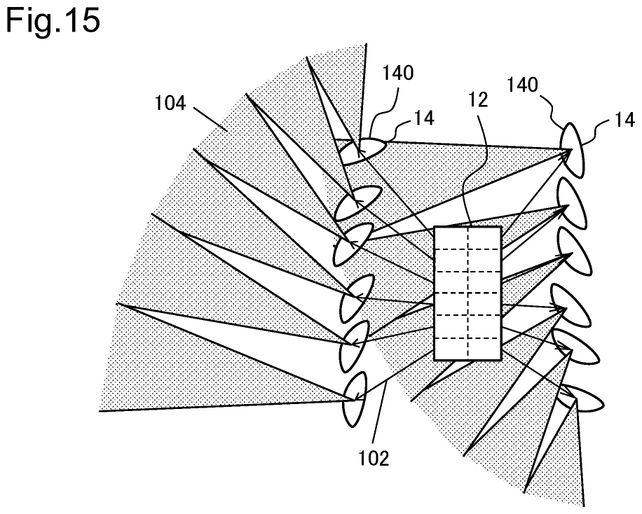

FIGS. 14 and 15 are conceptual diagrams for explaining another example related to reflection of light by the curved mirror 14. FIGS. 14 and 15 illustrate examples in which the spatial light signal (projection light 104) is projected in the direction of 180 degrees. FIG. 14 is a diagram of the spatial light modulator 12 as viewed from the minor axis direction. FIG. 15 is a diagram of the spatial light modulator 12 as viewed from the back side. In FIGS. 14 and 15, the light shielding band 13 is omitted. The plurality of curved mirrors 14 are associated with one of the plurality of modulation regions M set in the modulation part 120 of the spatial light modulator 12. In the example of FIGS. 14 and 15, the projection light 104 is enlarged along the horizontal direction (the vertical direction with respect to the sheet of FIG. 15) according to the curvature of the irradiation range of the modulated light 102 on the reflecting surface 140 of the curved mirror 14. The projection light 104 is also enlarged in the vertical direction (the vertical direction in the sheet of FIG. 15) as it goes away from the transmission device 21.

The plurality of curved mirrors 14 are disposed with the reflecting surface 140 facing different directions. The reflecting surfaces 140 of the six curved mirrors 14 disposed on the left side are directed to the left side in the plane of the paper of FIG. 15. The reflecting surfaces 140 of the six curved mirrors 14 disposed on the left side are responsible for the projection range of 90 degrees corresponding to the upper half on the left side in the plane of the paper of FIG. 15. The reflecting surfaces 140 of the six curved mirrors 14 disposed on the right side are directed to the left in the plane of the paper of FIG. 15. The reflecting surfaces 140 of the six curved mirrors 14 disposed on the right side cover a range of 90 degrees corresponding to the lower left half in the plane of the paper of FIG. 15. For example, when the projection angle of one curved mirror 14 is set to 15 degrees or more, the projection range of 180 degrees on the left can be covered by summing the projection angles taken charge of by the 12 curved mirrors 14.

The transmission device 10 may be provided with a projection optical system including a Fourier transform lens, a projection lens, and the like instead of the curved mirror 14. The transmission device 10 may be configured to directly project the light modulated by the modulation part 120 of the spatial light modulator 12 without including the curved mirror 14 or the projection optical system.

The control unit 15 controls the light source 11 and the spatial light modulator 12. For example, the control unit 15 is achieved by a microcomputer including a processor and a memory. The control unit 15 sets a phase image relevant to the projected image in the modulation part 120 in accordance with the aspect ratio of tiling set in the modulation part 120 of the spatial light modulator 12. The control unit 15 sets a phase image relevant to the projected image in each of the plurality of modulation regions M set in the modulation part 120 of the spatial light modulator 12. For example, the control unit 15 sets, in the modulation part 120, a phase image relevant to an image according to a use such as image display, communication, or distance measurement. The phase image of the projected image may be stored in advance in a storage unit (not illustrated). The shape and size of the image to be projected are not particularly limited.

The control unit 15 controls the spatial light modulator 12 such that a parameter that determines a difference between a phase of the parallel light 101 irradiated to the modulation part 120 of the spatial light modulator 12 and a phase of the modulated light 102 reflected by the modulation part 120 changes. For example, the parameter is a value related to optical characteristics such as a refractive index and an optical path length. For example, the control unit 15 adjusts the refractive index of the modulation part 120 by changing the voltage applied to the modulation part 120 of the spatial light modulator 12. The phase distribution of the parallel light 101 with which the modulation part 120 of the spatial light modulator 12 of a phase modulation type is irradiated is modulated according to the optical characteristics of the modulation part 120. The method of driving the spatial light modulator 12 by the control unit 15 is determined according to the modulation scheme of the spatial light modulator 12.

The control unit 15 drives the light source 11 in a state where the phase image relevant to the image to be displayed is set in the modulation part 120. As a result, the parallel light 101 emitted from the light source 11 is irradiated to the modulation part 120 of the spatial light modulator 12 in accordance with the timing at which the phase image is set in the modulation part 120 of the spatial light modulator 12. The parallel light 101 emitted to the modulation part 120 of the spatial light modulator 12 is modulated by the modulation part 120 of the spatial light modulator 12. The modulated light 102 modulated by the modulation part 120 of the spatial light modulator 12 is emitted toward the reflecting surface 140 of the curved mirror 14.

For example, the projection angle of the projection light 104 can be set to an angle by adjusting the curvature of the reflecting surface 140 of the curved mirror 14 included in the transmission device 21 and the distance between the spatial light modulator 12 and the curved mirror 14. If the plane mirror is disposed on the optical path of the modulated light 102 inside the transmission device 21, the projection angle of the projection light 104 can be variously set. For example, a transmission device 10 configured to project projection light in a direction of 360 degrees and a reception device configured to receive a spatial light signal arriving from a direction of 360 degrees are combined. With such a configuration, it is possible to achieve a communication device that transmits a spatial light signal in a direction of 360 degrees and receives a spatial light signal arriving from a direction of 360 degrees.

### Modification

Next, a modification of the present example embodiment will be described. Hereinafter, a modification (first modification) in which the positions where the light sources are disposed are different and a modification (second modification) in which the structures of the light shielding bands 13 are different will be described. The following modifications are merely examples and do not limit the modifications of the present example embodiment.

### First Modification

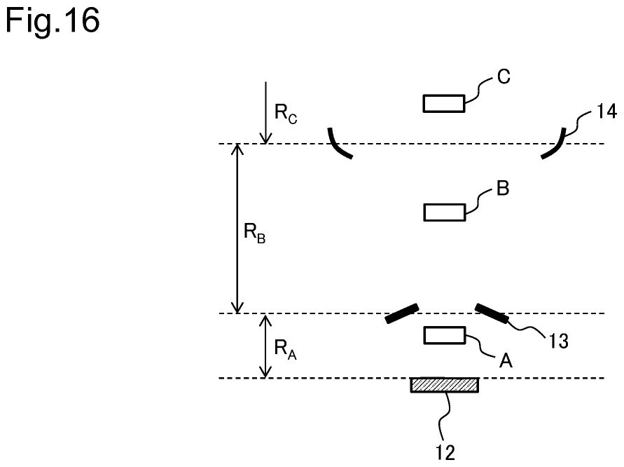

FIG. 16 is a conceptual diagram for explaining a position where the light source 11 is disposed. FIG. 16 is a diagram of the spatial light modulator 12 as viewed from the minor axis direction. The light source 11 can be disposed at three positions illustrated in FIG. 16. The position A is a region RA between the spatial light modulator 12 and the light shielding band 13. The position B is a region RB between the light shielding band 13 and the curved mirror 14. The position C is a region RC farther than the curved mirror 14 as viewed from the spatial light modulator 12. The distance to the spatial light modulator 12 is the shortest at the position A and the farthest at the position C. The above-described examples of FIGS. 12 to 15 are examples in which the light source 11 is installed at the position B.

The VCSEL is surface emission and has a relatively wide radiation angle. Therefore, the emitter 110 including the VCSEL can be disposed at the position A. When the emitter 110 is disposed at the position A, the collimator can be omitted from the emitter 110. When the emitter 110 is disposed at the position C, the collimator is required for the emitter 110. The PCSEL is surface emission and has a relatively narrow radiation angle. Therefore, by setting the effective light emission area slightly larger, the collimator can be omitted even if the emitter 110 configured by the PCSEL is disposed at the position C. The PCSEL is advantageous for higher output.

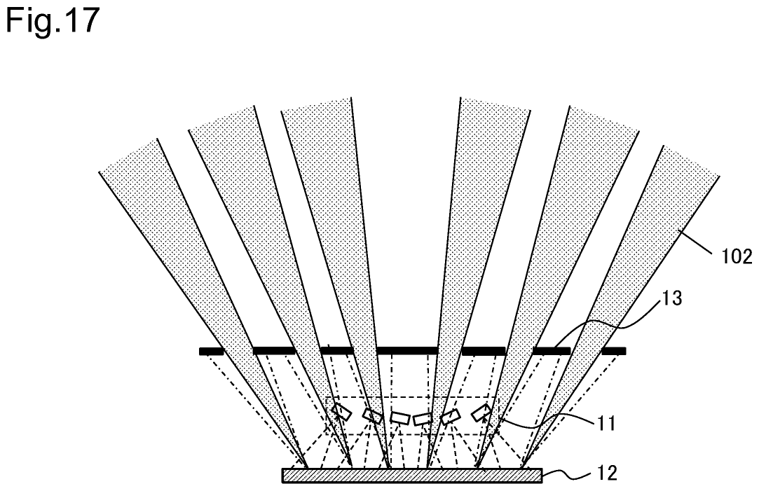

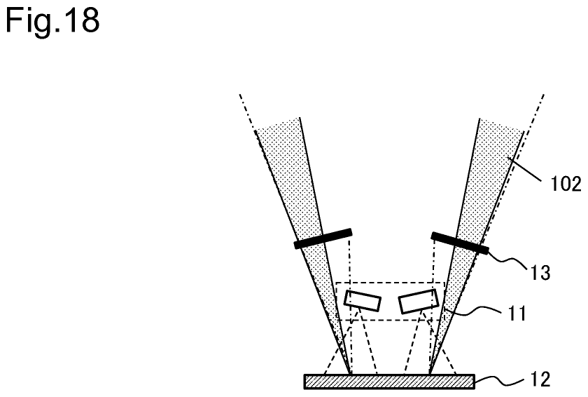

FIGS. 17 and 18 illustrate an example (first modification) in which the light source 11 is arranged in the region RA (position A in FIG. 16) between the spatial light modulator 12 and the light shielding band 13. FIG. 17 is a diagram of the spatial light modulator 12 as viewed from the major axis direction. FIG. 18 is a diagram of the spatial light modulator 12 as viewed from the minor axis direction. In FIGS. 17 and 18, the overlapping configuration is omitted. The light shielding band 13 is disposed at a position deviated from the optical path of the parallel light 101 emitted from the plurality of emitters 110. When the light source 11 is brought close to the spatial light modulator 12 as in the present modification, the transmission device 10 can be downsized. Even with the configuration of the present modification, if the emission angle of the laser light of the emitter 110 included in the light source 11 is sufficiently large, the spatial light signal can be transmitted in multiple directions. In the case of the configuration as in the present modification, the collimator can be omitted from the light source 11.

### Second Modification

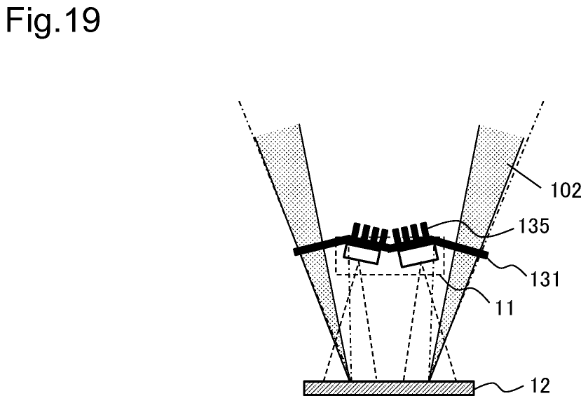

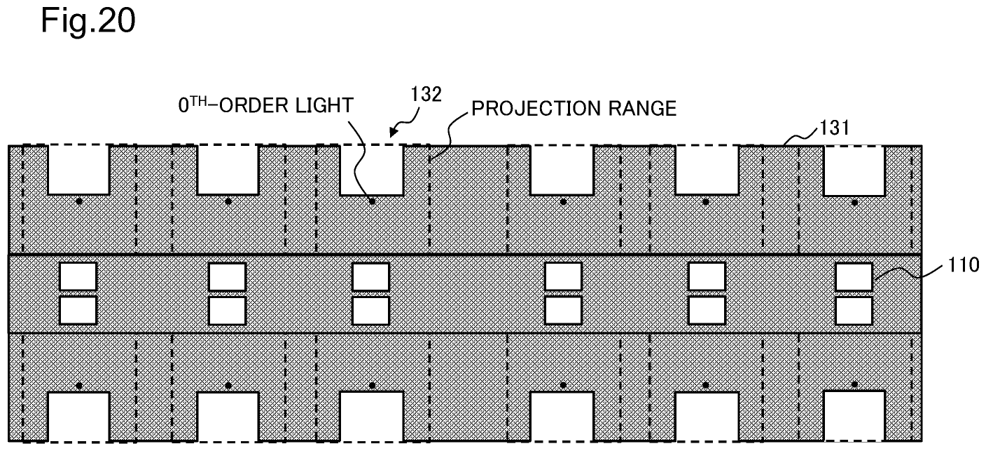

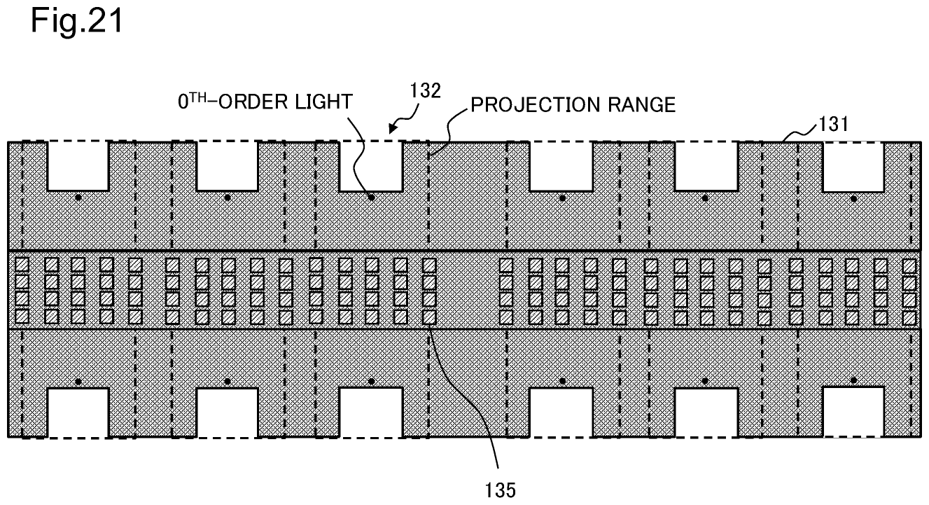

FIGS. 19 to 21 illustrate an example (second modification) of the integrated light shielding band 13. In the light shielding band 131 of the present modification, 12 openings 132 are formed. The plurality of emitters 110 constituting the light source 11 are arranged on one surface of the light shielding band 131. The surface (emission surface) on which the plurality of emitters 110 are arranged is directed to the modulation part 120 of the spatial light modulator 12.

A radiator 135 is formed on a surface opposite to the emission surface. The radiator 135 dissipates heat generated in response to emission of laser light by the emitter 110. For example, the light shielding band 131 is made of metal, carbon, resin, or the like having high thermal conductivity. As long as heat can be efficiently dissipated, the shape of the radiator 135 is not particularly limited. The radiator 135 may be thermally connected to a housing (not illustrated) of the transmission device 10. If the housing has high thermal conductivity, heat can be efficiently discharged.

According to the configuration of FIGS. 19 to 21, the light source 11 and the light shielding band 131 can be integrated. According to the configurations of FIGS. 19 to 21, by providing the radiator 135, the heat generated from the emitter 110 can be efficiently exhausted. In the configurations of FIGS. 19 to 21, the radiator 135 may be omitted.

As described above, the transmission device of the present example embodiment includes the light source, the spatial light modulator, the light shielding band, the plurality of curved mirrors, and the control unit. The light source includes a plurality of emitters. The light source emits parallel light. The spatial light modulator includes a modulation part. A plurality of modulation regions associated with each of the plurality of emitters are set in the modulation part. The control unit sets a phase image used for spatial light communication in each of the plurality of modulation regions allocated to the modulation part of the spatial light modulator. The control unit controls an emitter associated with each of the plurality of modulation regions so that each of the plurality of modulation regions is irradiated with light. The plurality of curved mirrors have curved reflecting surfaces. The reflecting surface has a curvature corresponding to a projection angle of projection light transmitted as a spatial light signal. The plurality of curved mirrors are disposed in association with each of the plurality of modulation regions so as to reflect the modulated light modulated by each of the plurality of modulation regions set in the modulation part of the spatial light modulator on the reflecting surface. The light shielding band is disposed between the spatial light modulator and the curved mirror. The light shielding band removes an unnecessary light component included in the modulated light modulated in each of the plurality of modulation regions. The modulated light from which the unnecessary light component is removed is reflected by the reflecting surface of the curved mirror and transmitted as a spatial light signal (projection light).

In the transmission device of the present example embodiment, the plurality of modulation regions set in the modulation part of the spatial light modulator is irradiated with the parallel light derived from the laser light emitted from the plurality of emitters. Unnecessary light components included in the modulated light modulated in the plurality of modulation regions are shielded when passing through the light shielding band. The light component of the spatial light signal included in the modulated light modulated in each of the plurality of modulation regions is transmitted as a spatial light signal by one of the curved mirrors associated with each of the plurality of modulation regions. Therefore, according to the transmission device of the present example embodiment, it is possible to transmit a spatial light signal from which an unnecessary light component has been removed to a communication target in multiple directions.

In one aspect of the present example embodiment, a plurality of modulation regions arranged in a lattice pattern are allocated to the modulation part. A dead zone in which the light emitted from the plurality of emitters included in the light source is not modulated is set between adjacent modulation regions. According to the present aspect, even if the partition wall is not provided between the adjacent modulation regions, the parallel light emitted to each of the modulation regions can be modulated under the condition set for the communication target associated with each of the modulation regions. According to the present aspect, since the partition wall is not provided between the adjacent modulation regions, the incident angle of the parallel light with respect to the modulation part can be increased, and the size of the transmission device can be reduced.

In one aspect of the present example embodiment, an emitter and a modulation region that are in a point-symmetric positional relationship with respect to a center point of an emission surface of a light source and a modulation surface of a modulation part are associated with each other. According to the present aspect, since the emitter and the modulation region in an oblique positional relationship are associated with each other, the distance between the light source and the spatial light modulator can be reduced. Therefore, according to the present aspect, the collimator can be omitted from the light source by bringing the light source and the spatial light modulator close to each other. According to the present aspect, by bringing the light source and the spatial light modulator close to each other, the size of the transmission device can be reduced.

In one aspect of the present example embodiment, in the light shielding band, an opening is formed at a position irradiated with the 0^{th}-order image included in the modulated light modulated in each of the plurality of modulation regions. The light shielding band is disposed at a position to shield the 0^{th}-order light and the light component of the higher-order image included in the modulated light. According to the present aspect, it is possible to transmit the spatial light signal from which unnecessary light components including the 0^{th}-order light and the higher-order image included in the modulated light are removed.

In one aspect of the present example embodiment, the plurality of curved mirrors are disposed with their reflecting surfaces facing different projection directions. For example, the curvature of the reflecting surface of the curved mirror is set to a curvature corresponding to the distance for transmitting the spatial light signal. According to the present aspect, the spatial light signal can be transmitted toward the communication targets in various directions by the plurality of curved mirrors disposed with the reflecting surfaces facing different projection directions. For example, according to the present aspect, the spatial light signal can be transmitted in the direction of 360 degrees in the horizontal plane by adjusting the direction and curvature of the reflecting surface included in the plurality of curved mirrors.

### Second Example Embodiment

Next, a communication device according to a second example embodiment will be described with reference to the drawings. The communication device of the present example embodiment has a configuration in which a reception device and a transmission device are combined. The transmission device has the configuration of the first example embodiment. The reception device receives the spatial light signal. Hereinafter, an example of a reception device having a light receiving function including a ball lens will be described. The communication device of the present example embodiment may include a reception device including a light receiving function that does not include a ball lens.

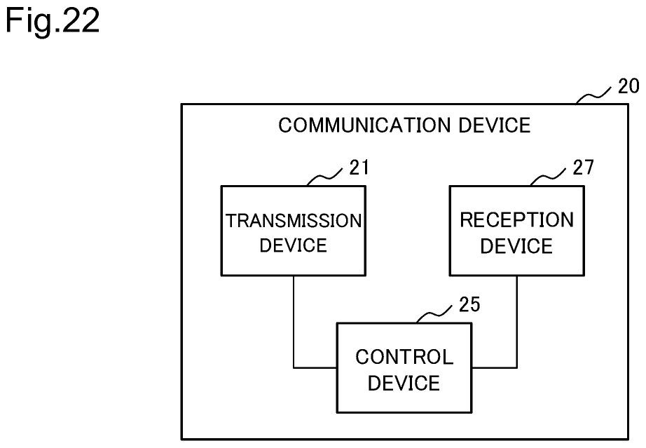

FIG. 22 is a conceptual diagram illustrating an example of a configuration of a communication device 20 according to the present example embodiment. The communication device 20 includes a transmission device 21, a control device 25, and a reception device 27. The communication device 20 transmits and receives spatial light signals to and from an external communication target. Therefore, an opening or a window for transmitting and receiving a spatial light signal is formed in the communication device 20. As will be described later, the communication device 20 may be equipped with a camera module or a light detection and ranging (LiDAR) module. A general-purpose module can be applied to the camera module and the LiDAR module.

The transmission device 21 is the transmission device of the first example embodiment. The transmission device 21 acquires a control signal from the control device 25. The transmission device 21 projects a spatial light signal according to the control signal. The spatial light signal projected from the transmission device 21 is received by a communication target (not illustrated) of a transmission destination of the spatial light signal.

The control device 25 acquires a signal output from the reception device 27. The control device 25 executes processing according to the acquired signal. The processing executed by the control device 25 is not particularly limited. The control device 25 outputs a control signal for transmitting an optical signal corresponding to the executed processing to the transmission device 21. For example, the control device 25 executes processing based on a predetermined condition according to information included in the signal received by the reception device 27. For example, the control device 25 executes processing designated by an administrator of the communication device 20 according to information included in the signal received by the reception device 27.

The reception device 27 receives a spatial light signal transmitted from a communication target (not illustrated). The reception device 27 converts the received spatial light signal into an electric signal. The reception device 27 outputs the converted electric signal to the control device 25. For example, the reception device 27 has a light receiving function including a ball lens. The reception device 27 may have a light receiving function that does not include a ball lens.

[Reception Device]

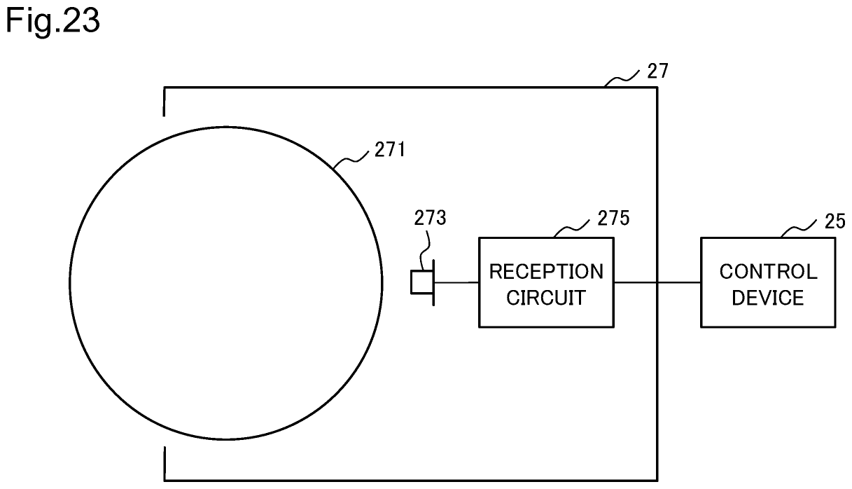

Next, a configuration of the reception device 27 will be described with reference to the drawings. FIG. 23 is a conceptual diagram for explaining an example of a configuration of the reception device 27. The reception device 27 includes a ball lens 271, a light receiving element 273, and a reception circuit 275. FIG. 23 is a side view of the internal configuration of the reception device 27 as viewed from the lateral direction. The position of the reception circuit 275 is not particularly limited. The reception circuit 275 may be disposed inside the reception device 27 or may be disposed outside the reception device 27. The function of the reception circuit 275 may be included in the control device 25.

The ball lens 271 is a spherical lens. The ball lens 271 is an optical element that collects a spatial light signal transmitted from a communication target. The ball lens 271 has a spherical shape when viewed from an angle. Apart of the ball lens 271 protrudes from an opening opened in a housing of the reception device 27. The ball lens 271 collects the incident spatial light signal. The spatial light signal incident on the ball lens 271 protruding from the opening is collected. As long as the spatial light signal can be condensed, a part of the ball lens 271 may not protrude from the opening.

Light (also referred to as an optical signal) derived from the spatial light signal condensed by the ball lens 271 is condensed toward the condensing region of the ball lens 271. Since the ball lens 271 has a spherical shape, the ball lens collects a spatial light signal arriving from any direction. That is, the ball lens 271 exhibits similar light condensing performance for a spatial light signal arriving from any direction. The light incident on the ball lens 271 is refracted when entering the inside of the ball lens 271. The light traveling inside the ball lens 271 is refracted again when being emitted to the outside of the ball lens 271. Most of the light emitted from the ball lens 271 is condensed in the condensing region.

For example, the ball lens 271 can be made of a material such as glass, crystal, or resin. In the case of receiving a spatial light signal in the visible region, the ball lens 271 can be achieved by a material such as glass, crystal, or resin that transmits/refracts light in the visible region. For example, the ball lens 271 can be achieved by optical glass such as crown glass or flint glass. For example, the ball lens 271 can be achieved by a crown glass such as BK (Boron Kron). For example, the ball lens 271 can be achieved by a flint glass such as Lanthanum Schwerflint (LaSF). For example, quartz glass can be applied to the ball lens 271. For example, a crystal such as sapphire can be applied to the ball lens 271. For example, a transparent resin such as acrylic can be applied to the ball lens 271.

In a case where the spatial light signal is light in a near-infrared region (hereinafter, also referred to as near infrared rays), a material that transmits near-infrared rays is used for the ball lens 271. For example, in a case of receiving a spatial light signal in a near-infrared region of about 1.5 micrometers (μm), a material such as silicon can be applied to the ball lens 271 in addition to glass, crystal, resin, and the like. In a case where the spatial light signal is light in an infrared region (hereinafter, also referred to as infrared rays), a material that transmits infrared rays is used for the ball lens 271. For example, in a case where the spatial light signal is an infrared ray, silicon, germanium, or a chalcogenide material can be applied to the ball lens 271. The material of the ball lens 271 is not limited as long as light in the wavelength region of the spatial light signal can be transmitted/refracted. The material of the ball lens 271 may be appropriately selected according to the required refractive index and use.

The ball lens 271 may be replaced with another concentrator as long as the spatial light signal can be condensed toward the region where the light receiving element 273 is disposed. For example, the ball lens 271 may be a light beam control element that guides the incident spatial light signal toward the light receiving unit of the light receiving element 273. For example, the ball lens 271 may have a configuration in which a lens or a light beam control element is combined. For example, a mechanism that guides the optical signal condensed by the ball lens 271 toward the light receiving unit of the light receiving element 273 may be added.

The light receiving element 273 is disposed at a subsequent stage of the ball lens 271. The light receiving element 273 is disposed in the condensing region of the ball lens 271. The light receiving element 273 includes a light receiving unit that receives the optical signal collected by the ball lens 271. The optical signal collected by the ball lens 271 is received by the light receiving unit of the light receiving element 273. The light receiving element 273 converts the received optical signal into an electric signal (hereinafter, also referred to as a signal). The light receiving element 273 outputs the converted signal to the reception circuit 275. FIG. 23 illustrates an example in which the light receiving element 273 is a single element. For example, a light receiving element array in which a plurality of light receiving elements 273 are arrayed may be disposed in the condensing region of the ball lens 271.

The light receiving element 273 receives light in a wavelength region of the spatial light signal to be received. For example, the light receiving element 273 has sensitivity to light in the visible region. For example, the light receiving element 273 has sensitivity to light in an infrared region. The light receiving element 273 has sensitivity to light having a wavelength in a 1.5 μm (micrometer) band, for example. The wavelength band of light with which the light receiving element 273 has sensitivity is not limited to the 1.5 μm band. The wavelength band of the light received by the light receiving element 273 can be set in accordance with the wavelength of the spatial light signal to be received. The wavelength band of the light received by the light receiving element 273 may be set to, for example, a 0.8 μm band, a 1.55 μm band, or a 2.2 μm band. The wavelength band of the light received by the light receiving element 273 may be, for example, a 0.8 to 1 μm band. A shorter wavelength band is advantageous for optical space communication during rainfall because absorption by moisture in the atmosphere is small. If the light receiving element 273 is saturated with intense sunlight, the light receiving element cannot read the optical signal derived from the spatial light signal. Therefore, a color filter that selectively passes the light of the wavelength band of the spatial light signal may be installed at the preceding stage of the light receiving element 273.

For example, the light receiving element 273 can be achieved by an element such as a photodiode or a phototransistor. For example, the light receiving element 273 is achieved by an avalanche photodiode. The light receiving element 273 achieved by the avalanche photodiode can support high-speed communication. The light receiving element 273 may be achieved by an element other than a photodiode, a phototransistor, or an avalanche photodiode as long as an optical signal can be converted into an electric signal. In order to improve the communication speed, the light receiving unit of the light receiving element 273 may be as small as possible. For example, the light receiving unit of the light receiving element 273 has a square light receiving surface having a side of about 5 mm (mm) For example, the light receiving unit of the light receiving element 273 has a circular light receiving surface having a diameter of about 0.1 to 0.3 mm. The size and shape of the light receiving unit of the light receiving element 273 may be selected according to the wavelength band, the communication speed, and the like of the spatial light signal.

For example, a polarizing filter (not illustrated) may be disposed in the preceding stage of the light receiving element 273. The polarizing filter is disposed in association with the light receiving unit of the light receiving element 273. For example, the polarizing filter is disposed to overlap the light receiving unit of the light receiving element 273. For example, the polarizing filter may be selected according to the polarization state of the spatial light signal to be received. For example, when the spatial light signal to be received is linearly polarized light, the polarizing filter includes a ½ wave plate. For example, when the spatial light signal to be received is circularly polarized light, the polarizing filter includes a ¼ wave plate. The polarization state of the optical signal having passed through the polarizing filter is converted according to the polarization characteristic of the polarizing filter.

The reception circuit 275 acquires a signal output from the light receiving element 273. The reception circuit 275 amplifies the signal from the light receiving element 273. The reception circuit 275 decodes the amplified signal. The signal decoded by the reception circuit 275 is used for any purpose. The use of the signal decoded by the reception circuit 275 is not particularly limited.

### Application Example

Next, an application example of the communication device 20 of the present example embodiment will be described with reference to the drawings. Hereinafter, four application examples (application example 1 to 4) will be described. In the following application example, an example in which a communication device on the management side/control side and a communication device on the managed side/controlled side transmit and receive a spatial light signal will be described. Any of the communication devices has the same configuration as the communication device according to the second example embodiment.

### Application Example 1

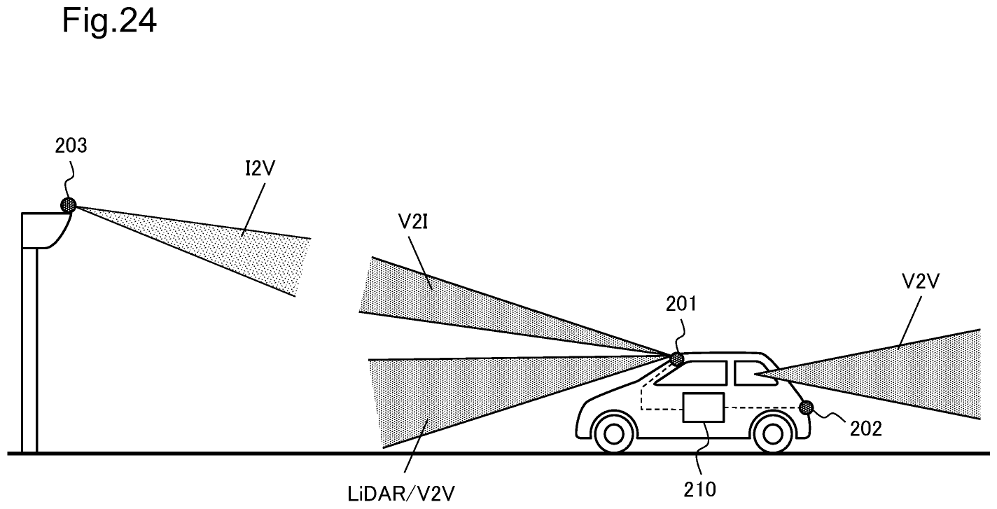

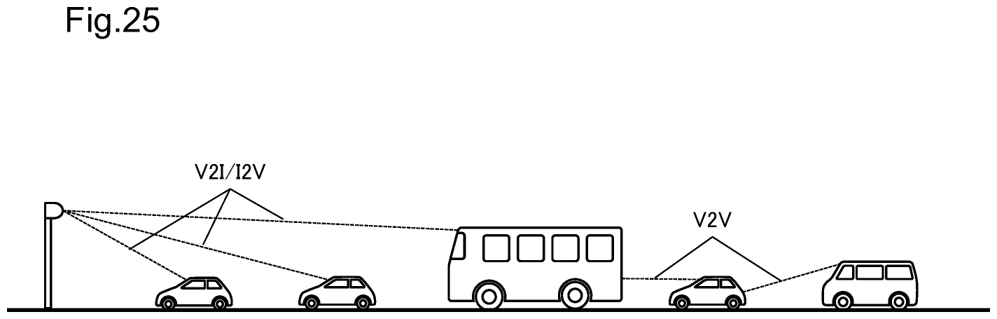

FIGS. 24 and 25 are conceptual diagrams for describing Application Example 1. The present application example is an example in which a spatial light signal is transmitted and received between a communication device mounted on a vehicle and a communication device installed on a road on which the vehicle travels. In the present application example, a communication device (communication device 201, communication device 202) is mounted on a front part and a rear part of the vehicle, and a communication device (communication device 203) on a road management side is disposed in a traffic light. In the present application example, a communication system is formed by the communication device 201 and the communication device 202 mounted on the vehicle and the communication device 203 on the road management side.

The communication device 201, the communication device 202, and the overall control device 210 are mounted on the vehicle. The communication device 201 is installed at the front part of the vehicle. The communication device 201 transmits a spatial light signal used for vehicle to infrastructure (V2I) communication and vehicle to vehicle (V2V) communication. The communication device 202 is installed in the rear part of the vehicle. The communication device 202 transmits a spatial light signal used for the V2V communication. The overall control device 210 is connected to the communication device 201 and the communication device 202. The position where the overall control device 210 is installed is not particularly limited.

The communication device 203 is disposed in a traffic light. The communication device 203 transmits a spatial light signal used for the infrastructure to vehicle (I2V) communication. The communication device 203 may be disposed in a facility other than the traffic light. For example, the communication device 203 may be disposed on a road sign, a pedestrian bridge, a tollgate, a street light, a telephone pole, or the like.

The communication device 201 mounted on the front part of the vehicle transmits spatial light signals in two directions in front of the vehicle. The communication device 201 transmits a spatial light signal directed obliquely forward and upward. The spatial light signal directed obliquely forward and upward is used in the vehicle to infrastructure (V2I) communication with the communication device 203 disposed in the traffic light. The communication device 201 transmits a spatial light signal directed to the forward front (including obliquely forward and downward). The spatial light signal directed to the forward front is used for the vehicle to vehicle (V2V) communication with a vehicle traveling ahead. In the communication device 201, a spatial light signal directed to the forward front is used for detection and distance measurement by a LiDAR module mounted on the vehicle.

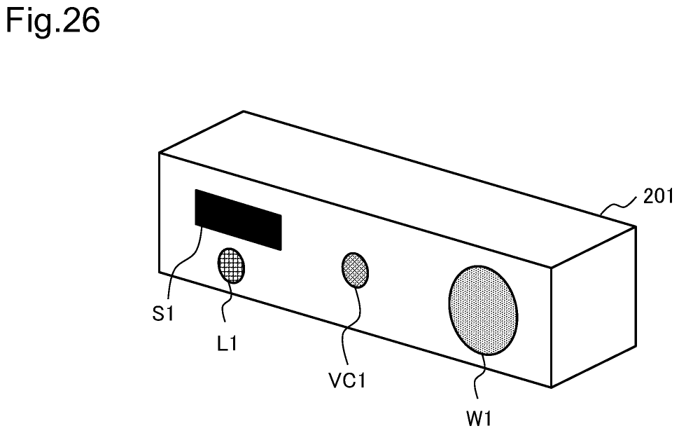

FIG. 26 is a conceptual diagram illustrating an example of a configuration of the communication device 201. FIG. 26 is a perspective view of the housing of the communication device 201 as viewed from diagonally above forward. A transmission slit S1, a reception window W1, a camera window VC1, and a LiDAR window Li are formed in a front part of the housing. The transmission slit S1 is an opening for transmitting a spatial light signal. The reception window W1 is an opening for receiving a spatial light signal. The camera window VC1 is an opening for photographing with a camera. The LiDAR window Li is an opening for receiving light used for detection and distance measurement. The opening in the front part of the housing may be covered with a transparent cover through which light to be transmitted and received such as visible light or infrared light is transmitted.

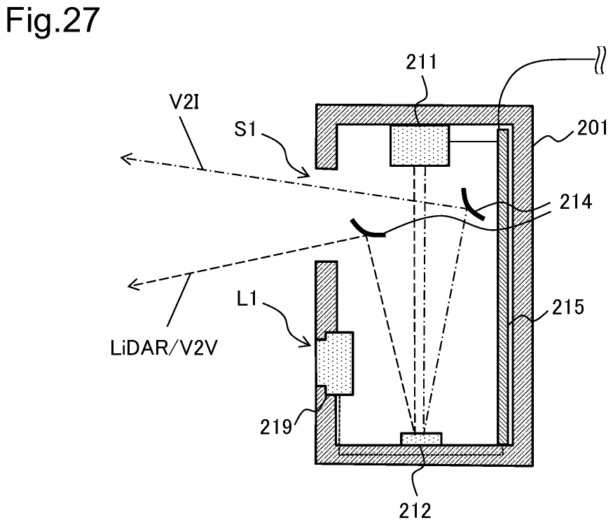

FIG. 27 is a conceptual diagram illustrating an example of a transmission mechanism in a housing of the communication device 201. FIG. 27 is a cross-sectional view illustrating a portion of the transmission mechanism. The transmission mechanism includes a light source 211, a spatial light modulator 212, a light shielding band (not illustrated), and a curved mirror 214. In FIG. 27, the light shielding band is omitted. The light source 211 is installed above the housing. The light source 211 has the same configuration as the light source 11 of the first example embodiment. The spatial light modulator 212 is installed below the housing. The spatial light modulator 212 has the same configuration as the spatial light modulator 12 of the first example embodiment. The light source 211 and the spatial light modulator 212 are connected to a substrate 215 common to the reception mechanism. A control function similar to that of the control device 25 in FIG. 22 is mounted on the substrate 215. The substrate 215 is connected to the overall control device 210 mounted on the vehicle. The light shielding band (not illustrated) has the same configuration as that of the first example embodiment. The plurality of curved mirrors 214 are disposed between the light source 211 and the spatial light modulator 212. The curved mirror 214 has the same configuration as the curved mirror 14 of the first example embodiment. The reflecting surfaces of the plurality of curved mirrors 214 are directed to the modulation part of the spatial light modulator 212 and the transmission slit S1. The plurality of curved mirrors 214 are divided into a mirror for the V2I communication and a mirror for the LiDAR/V2V communication.

The modulation part of the spatial light modulator 212 is irradiated with the parallel light emitted from the light source 211. Of the modulated light modulated by the modulation part, the light component that has passed through the light shielding band is reflected by the reflecting surface of the curved mirror 214. The modulated light (spatial light signal) reflected by the curved mirror 214 for V2I communication is transmitted forward and obliquely upward. The modulated light (spatial light signal) reflected by the curved mirror 214 for LiDAR/V2V communication is transmitted forward.

FIG. 27 illustrates a LiDAR module 219 mounted in the portion of the LiDAR window Li. The LiDAR module 219 receives reflected light of a spatial light signal for LiDAR. The LiDAR module 219 detects an object in front and measures a distance according to the received reflected light. The detailed configuration of the LiDAR module 219 will be omitted.

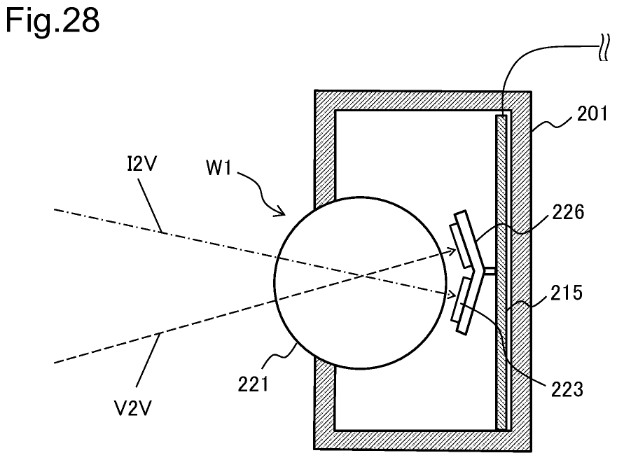

FIG. 28 is a conceptual diagram illustrating an example of a reception mechanism in a housing of the communication device 201. FIG. 28 is a cross-sectional view illustrating a portion of the reception mechanism. The reception mechanism includes a ball lens 221, a light receiving element 223, and a reception circuit (not illustrated). The reception circuit is mounted on the substrate 215. The ball lens 221 has the same configuration as the ball lens 271 of FIG. 23. A part of the ball lens 221 protrudes from the reception window W1. The light receiving element 223 is fixed to the housing by a support structure 226. The light receiving element 223 has the same configuration as the light receiving element 273 in FIG. 23. The light receiving element 223 is connected to the substrate 215 via the support structure 226. In the case of the example of FIG. 28, a plurality of light receiving elements 223 are disposed in the support structure 226. The plurality of light receiving elements 223 are connected to the reception circuit mounted on the substrate 215 via wiring (not illustrated) installed in the support structure 226.

The plurality of light receiving elements 223 are divided into one for I2V communication and one for V2V communication. The light receiving element 223 for I2V communication receives an optical signal derived from the spatial light signal transmitted from the communication device 203 disposed in the traffic light. The light receiving element 223 for V2V communication receives an optical signal derived from a spatial light signal transmitted from the communication device 203 mounted on the vehicle ahead. The optical signal received by the light receiving element 223 is decoded by a reception circuit mounted on the substrate 215. The decoded signal is transmitted to the overall control device 210.

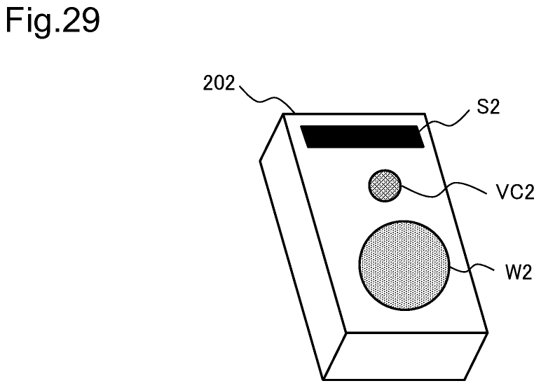

FIG. 29 is a conceptual diagram illustrating an example of a configuration of the communication device 202 mounted on a rear part of a vehicle. FIG. 29 is a perspective view of the housing of the communication device 202 as viewed from diagonally above forward. A transmission slit S2, a reception window W2, and a camera window VC2 are formed in the front part of the housing. The transmission slit S2 is an opening for transmitting a spatial light signal. The reception window W2 is an opening for receiving a spatial light signal. The camera window VC2 is an opening for photographing with a camera. The opening in the front part of the housing may be covered with a transparent cover through which light to be transmitted and received such as visible light or infrared light is transmitted. The configuration of the communication device 202 is similar to the configuration of the communication device 201 except that the LiDAR function is not mounted. The LiDAR function may be mounted in the configuration of the communication device 202.

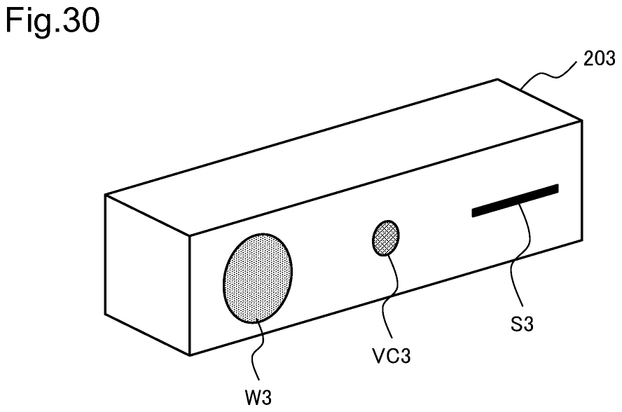

FIG. 30 is a conceptual diagram illustrating an example of a configuration of the communication device 203 installed in the traffic light. FIG. 30 is a perspective view of the housing of the communication device 203 as viewed from diagonally above forward. A transmission slit S3, a reception window W3, and a camera window VC3 are formed in the front part of the housing. The transmission slit S3 is an opening for transmitting a spatial light signal. The reception window W3 is an opening for receiving a spatial light signal. The camera window VC3 is an opening for photographing with a camera. The opening in the front part of the housing may be covered with a transparent cover through which light to be transmitted and received such as visible light or infrared light is transmitted. The configuration of the communication device 203 is similar to the configuration of the communication device 201 except that the LiDAR function is not mounted. The LiDAR function may be mounted in the configuration of the communication device 203.

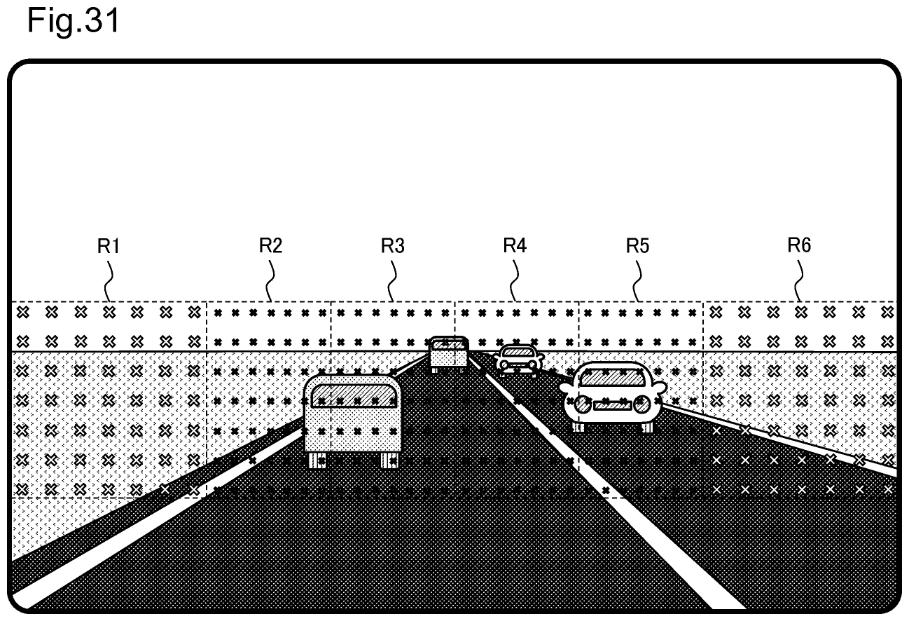

FIGS. 31 to 33 are conceptual diagrams for explaining an example of V2V communication between vehicles traveling on a road. FIGS. 31 to 33 illustrate a field of view from a driver's seat of the vehicle. The communication device 201 mounted on the front part of the vehicle projects a spatial light signal toward the front of the vehicle. In the example of FIGS. 31 to 33, an image pattern in which a plurality of dot lights are arranged in a lattice pattern is projected. The image patterns in the examples of FIGS. 31 to 33 are conceptual, and do not indicate actually displayed images. The communication device 201 projects a spatial light signal by being divided into six projection regions R1 to R6. It is assumed that a spatial light signal derived from laser light emitted from different emitters is projected to each of the projection regions R1 to R6. Among projection regions R1 to R6, a vehicle to be communicated is located relatively close to projection region R1 and projection region R6 at peripheral positions. Therefore, the projection region R1 and the projection region R6 are made to be related to each other in a wide range by increasing the curvature. Among the projection regions R1 to R6, with respect to the projection regions R1 to R4 at the front positions, since the vehicle to be communicated is located relatively far, the curvature is reduced to be related to the narrow range.

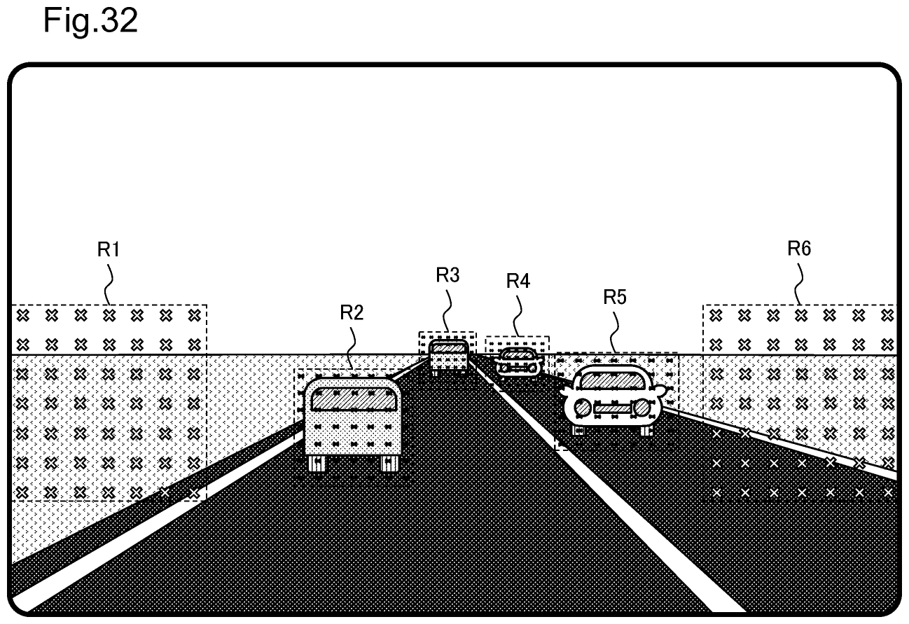

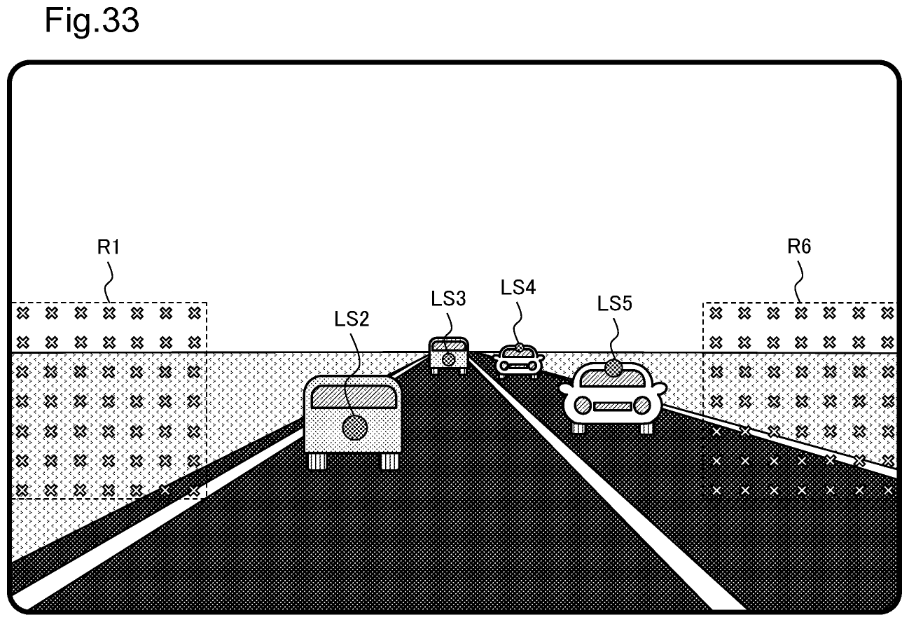

FIG. 31 illustrates a state of wide scan in a stage of searching for a vehicle to be communicated. In the wide scan, the spatial light signal is projected toward the preset projection regions R1 to R6. In the wide scan, a vehicle traveling ahead is detected. FIG. 32 illustrates a state of narrow scan in a stage of establishing communication with a communication target vehicle in response to detection of a vehicle traveling ahead. In the narrow scan, the projection region is narrowed with respect to the vehicle detected in the wide scan. In the example of FIG. 32, the projection regions R2 to R4 are associated with any vehicle traveling ahead. FIG. 33 illustrates a state of V2V communication in a stage where communication with a communication target vehicle is established. Spatial light signals (spot light LS2 to LS5) with a narrowed irradiation range are transmitted to the communication device 201 and the communication device 202 mounted on the vehicles with established communication.

In the present modification, a communication network including I2V communication, V2I communication, and V2V communication can be constructed using a communication device installed in a vehicle or a traffic light. For example, if the communication network constructed by the method of the present modification is used, the traffic of the vehicle traveling on the road can be smoothed according to the situation of the road.

### Application Example 2

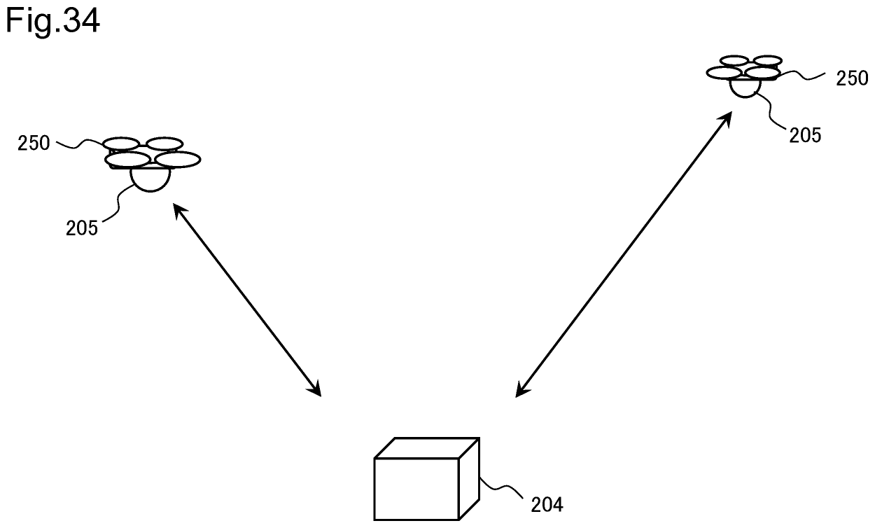

FIG. 34 is a conceptual diagram for explaining Application Example 2. The present application example is an example in which a spatial light signal is transmitted and received between a communication device 204 installed in a management station (not illustrated) on the ground and a communication device 205 mounted on a drone 250 flying in the sky. In the present application example, a communication system is formed by the communication device 204 of the management station and the communication device 205 mounted on the drone 250.

In the management station, the communication device 204 on the management side is disposed. For example, the communication device 204 is disposed on the rooftop of the building of the management station. The communication device 204 is disposed such that the optical receiver is positioned below the ball lens. The communication device 204 receives spatial light signals arriving from all directions above. In order to communicate with the drone 250 flying in a wide range, the communication device 204 may be equipped with a ball lens larger than the communication device 205. For example, if the diameter of the ball lens is changed from 70 mm (millimeter) to 90 to 100 mm, the reception distance of the spatial light signal becomes about 1.7 to 2.0 times longer. Since the communication device 204 is installed on the ground, there are few restrictions on the size thereof, and the size thereof can be increased.

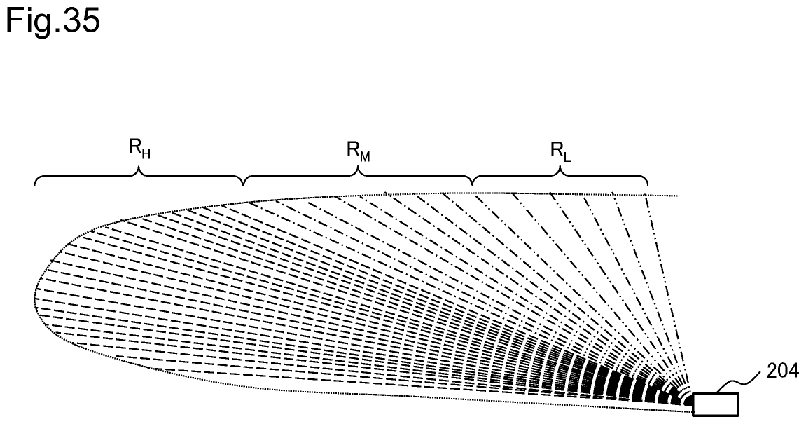

FIG. 35 is a conceptual diagram for explaining spread of a spatial light signal transmitted from the communication device 204. As the distance from the communication device 204 increases, the spatial light signal transmitted from the communication device 204 decreases. For example, if a low density spatial light signal is transmitted to a near region and a high density spatial light signal is transmitted to a far region, a range in which the drone 250 can receive the spatial light signal is widened. In the case of the example of FIG. 35, a low density region RL, a medium density region RM, and a high density region RH are allocated according to the distance from the communication device 204. A low density spatial light signal is transmitted to the low density region RL. A high density spatial light signal is transmitted to the high density region RH. A medium density spatial light signal corresponding to an intermediate between a low density and a high density is transmitted to the medium density region RM.

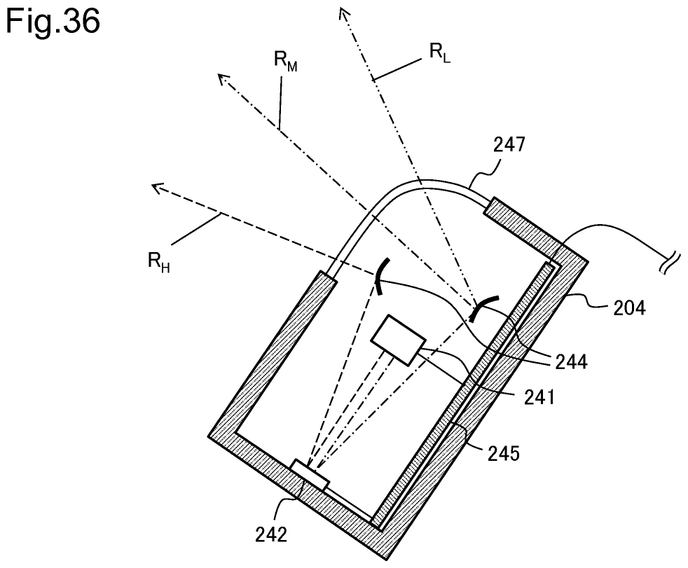

FIG. 36 is a conceptual diagram illustrating an example of a transmission mechanism in the housing of the communication device 204 disposed in the management station. FIG. 36 is a cross-sectional view illustrating a portion of the transmission mechanism. Since the reception mechanism of the communication device 204 is similar to that of Application Example 1, the description thereof will be omitted. The transmission mechanism includes a light source 241, a spatial light modulator 242, a light shielding band (not illustrated), and a curved mirror 244. In FIG. 36, the light shielding band is omitted. The light source 241 is installed near the center of the housing. The light source 241 has the same configuration as the light source 11 of the first example embodiment. The spatial light modulator 242 is installed below the housing. The spatial light modulator 242 has the same configuration as the spatial light modulator 12 of the first example embodiment. The light source 241 and the spatial light modulator 242 are connected to a common substrate 245 with a reception mechanism (not illustrated). A control function similar to that of the control device 25 in FIG. 22 is mounted on the substrate 245. The substrate 245 is connected to the overall control device 210 mounted on the vehicle. The light shielding band (not illustrated) has the same configuration as that of the first example embodiment. The plurality of curved mirrors 244 are disposed above the light source 211. The curved mirror 244 has the same configuration as the curved mirror 14 of the first example embodiment. The reflecting surfaces of the plurality of curved mirrors 244 are directed to the modulation part of the spatial light modulator 242 and a transparent cover 247. The transparent cover 247 covers an opening formed above the housing of the communication device 204. The transparent cover 247 includes a material through which light to be transmitted and received such as visible light or infrared light is transmitted. The transmission range of the plurality of curved mirrors 214 is allocated to at least one of the low density region RL, the medium density region RM, and the high density region RH. The modulated light reflected by the reflecting surfaces of the plurality of curved mirrors 214 is transmitted as a spatial light signal toward any one of the low density region RL, the medium density region RM, and the high density region RH. In the example of FIG. 36, it seems that the spatial light signals allocated to the low density region RL and the medium density region RM are reflected by the reflecting surface of the same curved mirror 244. The spatial light signals allocated to the low density region RL and the medium density region RM are reflected by different curved mirrors 244 disposed at different positions in the vertical direction of the paper surface.

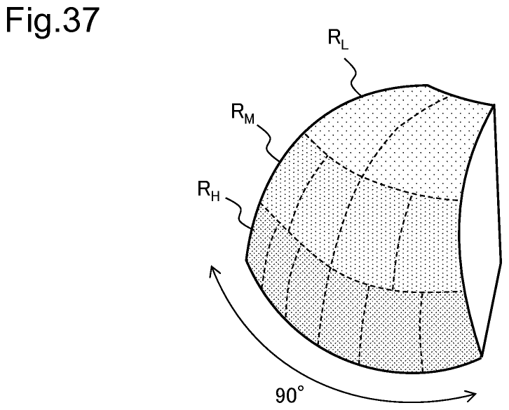

FIG. 37 is a conceptual diagram illustrating an example of spread of a spatial light signal transmitted from the communication device 204. In the example of FIG. 37, the spatial light signals are transmitted in different directions by the 12 curved mirrors 244. In the example of FIG. 37, one communication device 204 covers a projection range of 90 degrees in the horizontal plane. The density of the spatial light signal depends on the projection angle of the spatial light signal. The density of the spatial light signal is smaller as the projection angle is larger, and is larger as the projection angle is smaller. The projection angle of the spatial light signal is determined according to the curvature of the curved mirror 214. The larger the curvature of the curved mirror 214, the larger the projection angle of the spatial light signal, and the smaller the curvature of the curved mirror 214, the smaller the projection angle of the spatial light signal. That is, the density of the spatial light signal decreases as the curvature of the curved mirror 214 increases, and increases as the curvature of the curved mirror 214 decreases. Therefore, as compared with the curved mirror 214 allocated to the medium density region RM and the high density region RH, a mirror having a large curvature of the reflecting surface is used for the curved mirror 214 allocated to the low density region RL. In other words, as compared with the curved mirror 214 allocated to the medium density region RM and the low density region RL, a mirror having a smaller curvature of the reflecting surface is used for the curved mirror 214 allocated to the high density region RH. For example, as illustrated in FIG. 37, in a case where the communication device 204 can cover the projection range of 90 degrees in the horizontal plane, if the four communication devices 204 are combined, the projection range of 360 degrees in the horizontal plane can be covered.

In order to control the drone 250 flying at a position several kilometers (km) away, it is required to transmit a high-power spatial light signal. In order to continue to transmit such a high-power spatial light signal, it is necessary to transmit a high-power spatial light signal deviating from the standard defined by the law. For example, when a pulsed spatial light signal is transmitted with power of class 1 or less on average, a high-power spatial light signal that satisfies a standard defined by a law can be transmitted.

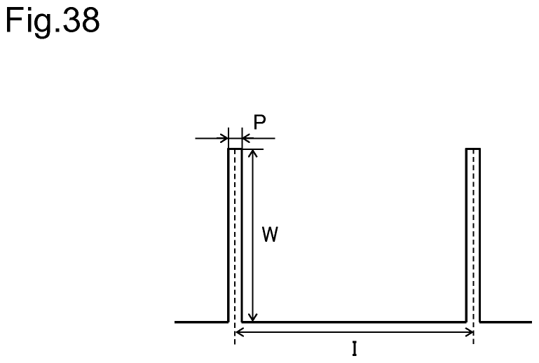

FIG. 38 is a conceptual diagram for explaining a pulsed spatial light signal (also referred to as a pulse wave). The pulse wave in FIG. 38 has an output of W, a pulse width of P, and a repetition time of I. The pulse width P is obtained from the band of the photodiode. A wavelength of 1550 nm (nanometer) is 600 MHz (megahertz) in terms of frequency. In this case, when the output W is 10 W (watts), the pulse width P is 10 nanoseconds, and the repetition time I is 10 microseconds, a throughput of 100 kbps (kilobits per second) is obtained. The wavelength of 840 to 950 nm is 50 MHz in terms of frequency. In this case, when the output W is 1 W, the pulse width P is 100 nanoseconds, and the repetition time I is 100 microseconds, a throughput of 10 kbps is obtained. That is, if the pulse wave is used, a throughput sufficient for operating the drone 250 can be obtained.

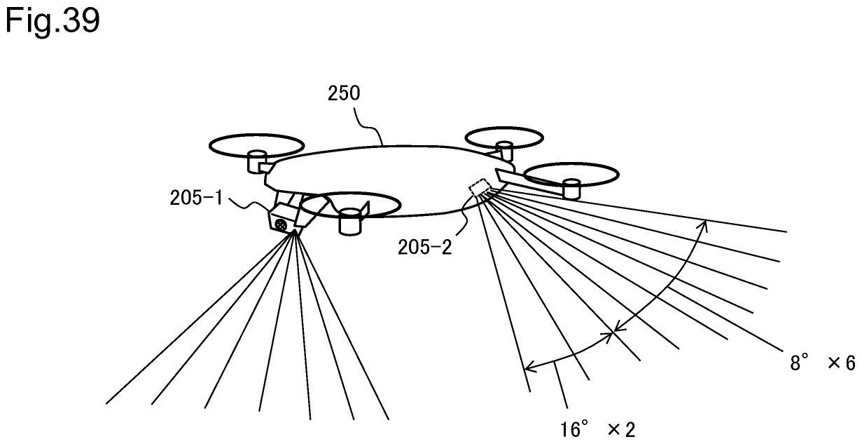

FIG. 39 is a conceptual diagram for explaining an example of the communication device 205 on which the drone 250 is mounted. In the example of FIG. 39, two communication devices 205 are mounted on the drone 250. A communication device 205-1 has a configuration similar to that of the communication device 201 (FIGS. 26 to 28) of the first modification. A communication device 205-2 has the same configuration as the communication device 202 (FIG. 29) and the communication device 203 (FIG. 30) of the first modification. The communication device 205-1 is mounted on the drone 250 by a gimbal in which a transmission/reception direction of a spatial light signal is directed in any direction. In the communication device 205-2, the transmission/reception direction of the spatial light signal is fixed. For example, the transmission direction of the spatial light signal by the communication device 205-2 may be limited to a one-dimensional range. The transmission direction of the spatial light signal by the communication device 205-2 is directed to the communication device 204 installed on the ground by the posture control of the drone 250. The reception mechanism may not be mounted in the communication device 205-2.

The communication device 205 on the managed side is mounted on the drone 250. For example, the drone 250 is equipped with a camera that captures an image of the surroundings and a sensor that measures a physical quantity of the surroundings. The communication device 205 is mounted below the drone 250. The communication device 205 is disposed such that the optical receiver is positioned above the ball lens. The communication device 205 receives a spatial light signal arriving from below. The communication device 205 is mounted with a ball lens smaller than the communication device 204.

According to the present application example, by using the large communication device 204, omnidirectional communication is achieved between the small communication device 205 mounted on the drone 250 flying in a wide range and the communication device 204. That is, according to the present application example, communication using the spatial light signal becomes possible between the drone 250 flying at a position in the sky and the management station on the ground. As a result, according to the present application example, it is possible to achieve a system in which the management station on the ground controls the flight of the drone 250. According to the present application example, it is possible to achieve a system that utilizes information collected by the drone 250 in real time.

### Application Example 3

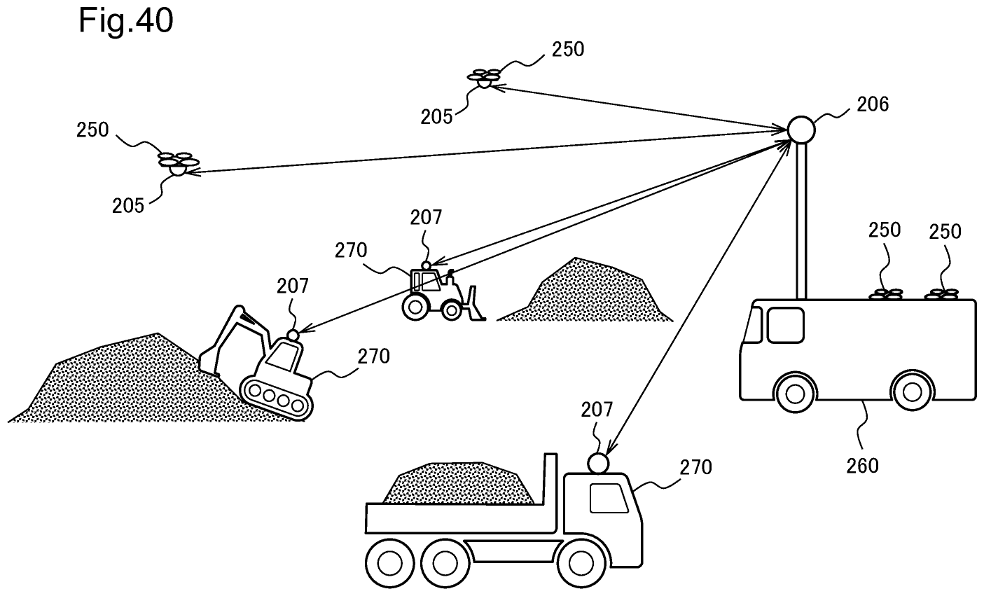

FIG. 40 is a conceptual diagram for explaining Application Example 3. The present application example is an example in which spatial light signals are transmitted and received between a communication device 207 mounted on a plurality of construction vehicles 270 operating at the construction site and a communication device 206 installed in a control vehicle 260 that controls the construction vehicles 270. In the present application example, a communication system is formed by the communication device 206 of the control vehicle 260 and the communication device 207 mounted on the construction vehicle 270.

In the present application example, the drone 250 of the second modification flies above the construction site. The drone 250 is controlled by the control vehicle 260, and acts as a repeater when a shielding object enters between the communication device 206 of the control vehicle 260 and the communication device 207 of the construction vehicle 270. In the example of FIG. 40, a power feeding device (not illustrated) capable of feeding power to the drone 250 is mounted on the upper part of the control vehicle 260. For example, the drone 250 captures an image of a construction site from above or performs distance measurement.

The control vehicle 260 is parked at or near a construction site. The communication device 206 on the control side is disposed in the control vehicle 260. For example, the communication device 206 is disposed above a pillar installed on the upper part of the control vehicle 260. The height of the pillar may be as high as possible so that the entire area of the construction site can be set to the communication range. For example, without using the control vehicle 260, the communication device 206 may be installed at a construction site or on an upper portion of a pillar installed near the construction site. The communication device 206 is connected to a control system (not illustrated) that controls the construction vehicle 270 operating at a construction site.

The communication device 206 is disposed such that the position of the optical receiver with respect to the ball lens is located on the opposite side of the construction site. The communication device 206 receives a spatial light signal arriving from the direction of the construction site. The light receiving direction of the communication device 206 is set such that the flying range of the drone 250 is included in the communication range. In order to communicate with the construction vehicle 270 moving in a wide range at a construction site, the communication device 206 is mounted with a ball lens larger than the communication device 207. Since the communication device 206 is installed on the ground, there are few restrictions on the size thereof, and the size thereof can be increased.

A plurality of construction vehicles 270 operate at a construction site. The plurality of construction vehicles 270 operate under the control of the control system connected to the communication device 206. The communication device 207 on the controlled side is mounted on the construction vehicle 270. For example, the construction vehicle 270 is equipped with an automatic driving device (not illustrated) that operates the construction vehicle 270 in accordance with a spatial light signal transmitted from the communication device 206.

The communication device 207 is mounted on an upper side of the construction vehicle 270. The communication device 207 is disposed such that the optical receiver is positioned below the ball lens. The communication device 207 receives a spatial light signal arriving from above. The communication device 207 is mounted with a ball lens smaller than the communication device 206.

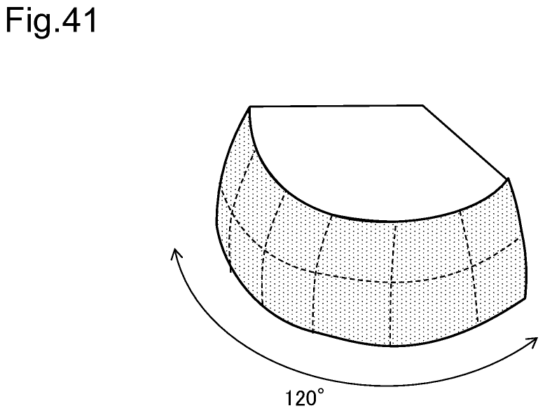

FIG. 41 is a conceptual diagram illustrating an example of spread of a spatial light signal transmitted from the communication device 207. In the example of FIG. 41, the spatial light signals are transmitted in different directions by the 12 curved mirrors 244. In the example of FIG. 41, one communication device 207 covers a projection range of 120 degrees in the horizontal plane. In this case, if the three communication devices 207 are used, a projection range of 360 degrees in the horizontal plane can be covered.

For example, the control device connected to the communication device 206 specifies the position of the communication device 207 in which communication is interrupted using information such as image information and distance measurement information acquired by the drone 250. The control device selects the drone 250 used for relaying the spatial light signal according to the specified position of the communication device 207. The control device can transmit the spatial light signal to the communication device 207 whose communication is interrupted by relaying the selected drone 250.

According to the present application example, the construction vehicle 270 operating at a construction site can be controlled by using the communication device 206 mounted on the control vehicle 260. According to the present application example, it is possible to achieve a system that automatically operates the construction vehicle 270 operating at a construction site while utilizing the information collected by the drone 250.

### Application Example 4

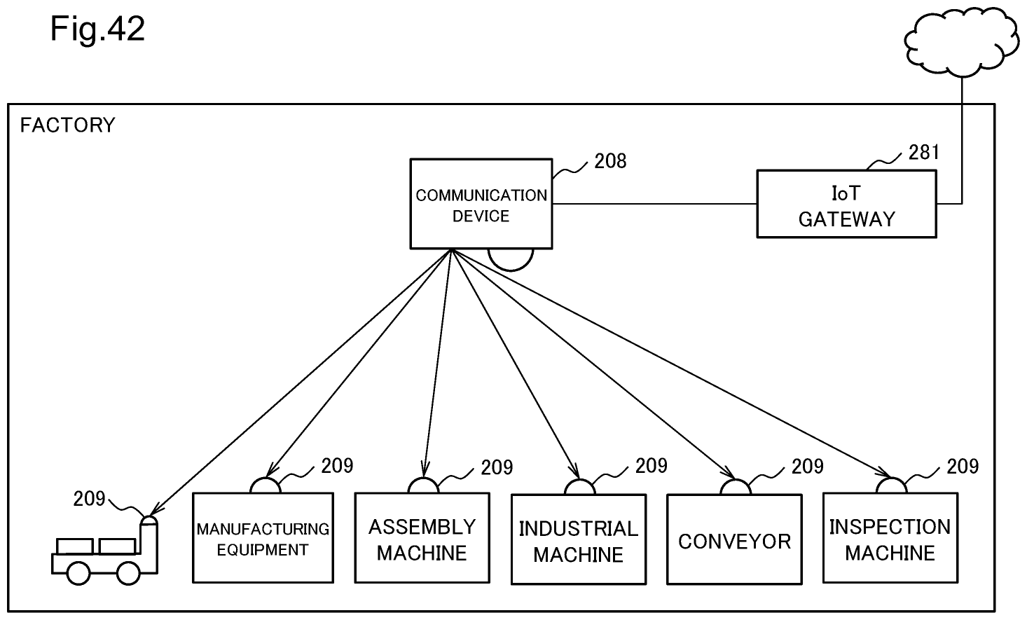

FIG. 42 is a conceptual diagram for explaining Application Example 4. The present application example is an example in which a spatial light signal is transmitted and received between a communication device 209 mounted on a device operating in a factory and a communication device 208 connected to a management system (not illustrated) that manages these manufacturing devices. In the present application example, an example in which the communication device 208 is disposed on the ceiling of the factory and the communication device 209 is mounted on a plurality of devices will be described. A plurality of communication devices 208 may be disposed inside the factory. For example, the plurality of communication devices 208 are connected so as to be able to perform high-speed communication. In the present application example, a communication system is formed by the communication device 208 installed on the ceiling and the communication devices 209 mounted on a plurality of devices.

The communication device 208 is connected to an IoT gateway 281 (IoT: Internet of Things). The IoT gateway 281 has a router function of relaying data collected by a plurality of devices and relaying data transmitted from a management system. The IoT gateway 281 is connected to the management system constructed in a cloud or a server via the Internet. The communication load can be reduced by processing the enormous data collected by the plurality of devices by the IoT gateway 281 and then transmitting the data to the management system. The management system may be constructed in a terminal device inside the factory.

The communication device 208 is disposed on a ceiling where a plurality of devices can be looked down. As long as spatial light signals can be exchanged with a plurality of devices, the position where the communication device 208 is disposed is not limited. For example, the communication device 208 may be installed on a wall of a factory or the like. The communication device 208 is disposed such that the position of the optical receiver with respect to the ball lens is located on the ceiling side. The communication device 208 receives spatial light signals transmitted from a plurality of devices installed inside the factory. The communication device 208 transmits a spatial light signal to a plurality of devices installed inside the factory. In order to communicate with devices disposed in a wide range inside the factory, the communication device 208 is mounted with a ball lens larger than the communication device 209.

A plurality of devices operate inside the factory. In the example of FIG. 42, a conveyance robot, manufacturing equipment, an assembly machine, an industrial machine, a conveyor, and an inspection machine are disposed. The communication device 209 on the managed side is mounted on each of the plurality of devices. The communication device 209 is mounted on the upper side of the device. The communication device 209 is disposed such that the optical receiver is positioned below the ball lens. The communication device 209 receives the spatial light signal transmitted from the upper communication device 208. The communication device 209 transmits a spatial light signal toward the upper communication device 208. The communication device 209 is mounted with a ball lens smaller than the communication device 208.

For example, a management system connected to the communication device 208 uses data collected by a plurality of devices to manage operation states of the devices. For example, the management system displays the operating state of the device operating inside the factory on a screen of a terminal device (not illustrated) handled by the administrator. For example, the management system transmits a control signal to the devices according to the grasped operation state.

According to the present application example, it is possible to manage the device operating inside the factory by using the communication device 208 installed inside the factory. According to the present application example, since the spatial light signal is exchanged between the communication device 208 and the communication device 209, the wiring can be omitted. Unlike wireless communication, communication using a spatial light signal is less likely to be restricted in the number of devices that can be connected at the same time. Communication using a spatial light signal is less susceptible to noise inside a factory. According to the present application example, it is possible to achieve a system that automatically controls a plurality of devices operating in a factory while utilizing data collected by a plurality of devices.

As described above, the communication device according to the present example embodiment includes the reception device, the transmission device, and the control device. The reception device receives the spatial light signal. The transmission device includes a light source, a spatial light modulator, a light shielding band, a plurality of curved mirrors, and a control unit. The light source includes a plurality of emitters. The light source emits parallel light. The spatial light modulator includes a modulation part. A plurality of modulation regions associated with each of the plurality of emitters are set in the modulation part. The control unit sets a phase image used for spatial light communication in each of the plurality of modulation regions allocated to the modulation part of the spatial light modulator. The control unit controls an emitter associated with each of the plurality of modulation regions so that each of the plurality of modulation regions is irradiated with light. The plurality of curved mirrors have curved reflecting surfaces. The reflecting surface has a curvature corresponding to a projection angle of projection light transmitted as a spatial light signal. The plurality of curved mirrors are disposed in association with each of the plurality of modulation regions so as to reflect the modulated light modulated by each of the plurality of modulation regions set in the modulation part of the spatial light modulator on the reflecting surface. The light shielding band is disposed between the spatial light modulator and the curved mirror. The light shielding band removes an unnecessary light component included in the modulated light modulated in each of the plurality of modulation regions. The modulated light from which the unnecessary light component is removed is reflected by the reflecting surface of the curved mirror and transmitted as a spatial light signal (projection light). The control device acquires a signal based on a spatial light signal from another communication device received by the reception device. The control device executes processing according to the acquired signal. The control device causes the transmission device to transmit a spatial light signal corresponding to the executed processing.

In the communication device of the present example embodiment, the plurality of modulation regions set in the modulation part of the spatial light modulator are irradiated with the parallel light derived from the laser light emitted from the plurality of emitters. Unnecessary light components included in the modulated light modulated in the plurality of modulation regions are shielded when passing through the light shielding band. The light component of the spatial light signal included in the modulated light modulated in each of the plurality of modulation regions is transmitted as a spatial light signal by one of the curved mirrors associated with each of the plurality of modulation regions. Therefore, according to the communication device of the present example embodiment, it is possible to transmit a spatial light signal from which an unnecessary light component has been removed to a communication target in multiple directions.

A communication system according to an aspect of the present example embodiment includes a plurality of the above-described communication devices. In a communication system, a plurality of communication devices are disposed to transmit and receive spatial light signals to and from each other. According to the present aspect, it is possible to achieve a communication network that transmits and receives a spatial light signal.

### Third Example Embodiment

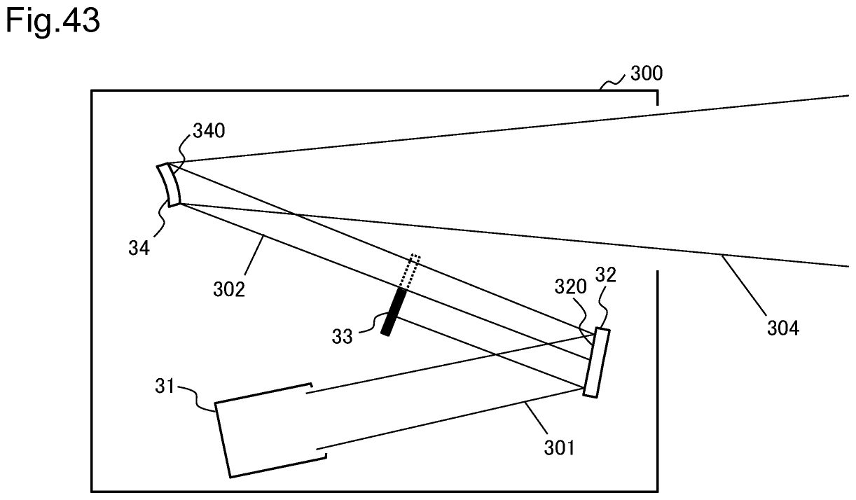

Next, a transmitter according to a third example embodiment will be described with reference to the drawings. The transmitter in the present example embodiment has a configuration in which the transmitter in the first example embodiment is simplified. FIG. 43 is a conceptual diagram illustrating an example of a configuration of a transmitter 300 according to the present example embodiment. FIG. 43 is a side view of the internal configuration of the transmitter 300 as viewed from the lateral direction. The transmitter 300 includes a light source 31, a spatial light modulator 32, a light shielding band 33, and a plurality of curved mirrors 34.

The light source 31 includes a plurality of emitters. The light source 31 emits parallel light 301. The spatial light modulator 32 includes a modulation part 320 in which a plurality of modulation regions associated with each of a plurality of emitters are set. The plurality of curved mirrors 34 have curved reflecting surfaces 340. The reflecting surface of the curved mirror 34 has a curvature corresponding to the projection angle of the projection light transmitted as the spatial light signal. The plurality of curved mirrors 34 are disposed in association with each of the plurality of modulation regions so that the modulated light 302 modulated in each of the plurality of modulation regions set in the modulation part 320 of the spatial light modulator 32 is reflected by the reflecting surface 340. The light shielding band 33 is disposed between the spatial light modulator 32 and the curved mirror 34. The light shielding band 33 removes an unnecessary light component included in the modulated light 302 modulated in each of the plurality of modulation regions. The modulated light 302 from which an unnecessary light component has been removed is reflected by the reflecting surface 340 of the curved mirror 34 and transmitted as a spatial light signal (projection light 304).

As described above, in the transmitter of the present example embodiment, the plurality of modulation regions set in the modulation part of the spatial light modulator are irradiated with the parallel light derived from the laser light emitted from the plurality of emitters. Unnecessary light components included in the modulated light modulated in the plurality of modulation regions are shielded when passing through the light shielding band. The light component of the spatial light signal included in the modulated light modulated in each of the plurality of modulation regions is transmitted as a spatial light signal by one of the curved mirrors associated with each of the plurality of modulation regions. Therefore, according to the transmitter of the present example embodiment, it is possible to transmit a spatial light signal from which an unnecessary light component has been removed to a communication target in multiple directions.

(Hardware)

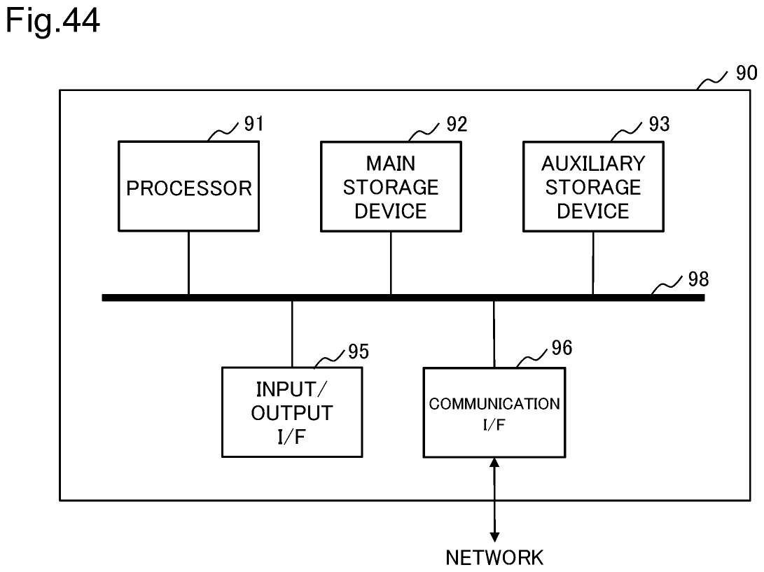

Here, a hardware configuration for executing the control and processing according to each example embodiment of the present disclosure will be described using an information processing device 90 (computer) of FIG. 44 as an example. The information processing device 90 in FIG. 44 is a configuration example for executing the control and processing of each example embodiment, and does not limit the scope of the present disclosure.

As illustrated in FIG. 44, the information processing device 90 includes a processor 91, a main storage device 92, an auxiliary storage device 93, an input/output interface 95, and a communication interface 96. In FIG. 44, the interface is abbreviated as an I/F. The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via the communication interface 96.

The processor 91 develops a program (instruction) stored in the auxiliary storage device 93 or the like in the main storage device 92. For example, the program is a software program for executing the control and processing of each example embodiment. The processor 91 executes the program developed in the main storage device 92. The processor 91 executes the control and processing according to each example embodiment by executing the program.

The main storage device 92 has an area in which a program is developed. A program stored in the auxiliary storage device 93 or the like is developed in the main storage device 92 by the processor 91. The main storage device 92 is implemented by, for example, a volatile memory such as a dynamic random access memory (DRAM). A nonvolatile memory such as a magneto resistive random access memory (MRAM) may be configured and added as the main storage device 92.

The auxiliary storage device 93 stores various data such as programs. The auxiliary storage device 93 is implemented by a local disk such as a hard disk or a flash memory. Various data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When a touch panel is used as the input device, a screen having a touch panel function serves as an interface. The processor 91 and the input device are connected via the input/output interface 95.

The information processing device 90 may be provided with a display device for displaying information. In a case where a display device is provided, the information processing device 90 may include a display control device (not illustrated) for controlling display of the display device. The display device may be connected to the information processing device 90 via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of the hardware configuration for enabling the control and processing according to each example embodiment of the present invention. The hardware configuration of FIG. 44 is an example of a hardware configuration for executing the control and processing of each example embodiment, and does not limit the scope of the present invention. A program for causing a computer to execute the control and processing according to each example embodiment is also included in the scope of the present invention.

Further, a program recording medium in which the program according to each example embodiment is recorded is also included in the scope of the present invention. The recording medium can be implemented by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium. When a program executed by the processor is recorded in a recording medium, the recording medium is associated to a program recording medium.

The components of each example embodiment may be combined. The components of each example embodiment may be implemented by software. The components of each example embodiment may be implemented by a circuit.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A transmitter comprising:
a light source that includes a plurality of emitters;
a spatial light modulator that includes a modulation part in which a plurality of modulation regions associated with each of a plurality of the emitters are set;
a plurality of curved mirrors that have a curved reflecting surface having a curvature relevant to a projection angle of projection light transmitted as a spatial light signal and disposed in association with each of a plurality of the modulation regions in such a way that, on the reflecting surface, modulated light modulated in each of a plurality of the modulation regions set in the modulation part of the spatial light modulator is reflected; and
a light shielding band that is disposed between the spatial light modulator and the curved mirror and removes an unnecessary light component included in the modulated light modulated in each of a plurality of the modulation regions.

2. The transmitter according to claim 1, wherein a plurality of the modulation regions arranged in a lattice pattern are allocated to the modulation part, and a dead zone in which light emitted from a plurality of the emitters included in the light source is not modulated is set between the modulation regions adjacent to each other.

3. The transmitter according to claim 2, wherein the emitter and the modulation region in a point-symmetric positional relationship with respect to a center point of an emission surface of the light source and a modulation surface of the modulation part are associated with each other.

4. The transmitter according to claim 1, wherein
the light shielding band includes an opening that is formed at a position irradiated with a 0^{th}-order image included in the modulated light modulated in each of a plurality of the modulation regions, and the light shielding band is disposed at a position to shield light components of a 0^{th}-order light and a higher-order image included in the modulated light.

5. The transmitter according to claim 1, wherein a plurality of the curved mirrors are disposed with the reflecting surface facing different projection directions.

6. The transmitter according to claim 5, wherein a curvature of the reflecting surface of the curved mirror is set to a curvature corresponding to a distance for transmitting a spatial light signal.

7. The transmitter according to claim 1, wherein
a plurality of the emitters are disposed on a first surface of the light shielding band, and
a radiator is formed on a second surface of the light shielding band.

8. A transmission device comprising:
the transmitter according to claim 1;
a memory storing instructions; and
a processor connected to the memory and configured to execute the instructions to
set a phase image used for spatial light communication in each of a plurality of modulation regions allocated to a modulation part of a spatial light modulator included in the transmitter, and
control an emitter associated with each of a plurality of the modulation regions in such a way that each of a plurality of the modulation regions is irradiated with light.

9. A communication device comprising:
the transmission device according to claim 8;
a reception device that receives a spatial light signal; and
a control device that acquires a signal based on a spatial light signal from another communication device received by the reception device, executes processing according to the acquired signal, and causes the transmission device to transmit a spatial light signal according to the executed processing.

10. A communication system comprising:
a plurality of the communication devices according to claim 9, wherein
a plurality of the communication devices are disposed to transmit and receive spatial light signals to and from each other.
